(19) United States
(12) Patent Application Publication
(10) Pub. No.: US 2026/0102740 A1
(43) Pub. Date: Apr. 16, 2026

(54) Electrodialysis Systems and Methods

(71) Applicant: Yale University, New Haven, CT (US)

(72) Inventors: Menachem Elimelech, New Haven, CT (US); Sohum Patel, New Haven, CT (US)

(21) Appl. No.: 19/355,513

(22) Filed: Oct. 10, 2025

Related U.S. Application Data
(60) Provisional application No. 63/706,832, filed on Oct. 14, 2024.

(51) Int. Cl. B01D 61/48; B01D 61/52; B01D 61/54; C02F 1/469

(52) U.S. Cl. CPC B01D 61/48; B01D 61/52; B01D 61/54; C02F 1/4695; C02F 2201/004

(57) ABSTRACT

Described herein is an electrodialysis system, comprising a solid-state electrolyte configured to allow ions to flow from the one chamber through the solid-state electrolyte and into another chamber.

Also described herein is a method of purifying an ion in a solution, the method comprising the steps of: providing a feed solution comprising an ion; contacting the feed solution with a solid-state electrolyte; applying a current to the solid-state electrolyte such that the ion passes through the solid-state electrolyte to create a recovery solution comprising the ion; and collecting the ion.

### CROSS REFERENCE TO RELATED APPLICATIONS

The present application claims priority to U.S. Provisional Application No. 63/706,832, filed Oct. 14, 2024, which is incorporated by reference herein in its entirety.

### STATEMENT REGARDING FEDERALLY SPONSORED RESEARCH OR DEVELOPMENT

This invention was made with government support under Grant No. CBET-2110138, awarded by The National Science Foundation, Grant No. CBET-2001219, awarded by The National Science Foundation, and Grant No. EEC-1449500, awarded by The National Science Foundation. The Government has certain rights in the invention.

### BACKGROUND OF THE INVENTION

The development of lithium-ion batteries has revolutionized the electric vehicle industry. As global decarbonization efforts continue to gain momentum, it is projected that over half of worldwide vehicle sales will be electric by the year 2035. While such widespread electrification of the transportation sector is advantageous in reducing overall greenhouse gas emissions, the rapid transition to electric vehicles (EVs) is expected to place severe strain on the supply chain of critical minerals used in electric vehicle batteries. Due to their low cost and unparalleled energy density, lithium ion batteries are expected to remain the dominant battery chemistry for EVs. While the need for some critical minerals in lithium ion batteries, including cobalt and nickel, may potentially be eliminated through the development of alternate cathode materials, lithium remains an essential component which is required in substantial quantities (approximately 8 kg in a single EV battery pack).

Demand for lithium is anticipated to grow exponentially over the next decade, reaching values beyond what can be attained from conventional sources, such as mining of lithium ores or extraction from lithium rich brines, by the year 2030. Effectively addressing this lithium supply gap will require extraction of lithium from unconventional aqueous sources, such as oil and gas produced water, salt lakes, and geothermal brines (D. Castelvecchi, Nature 596, 336-339 (2021); C. J. Xu et al., Commun Mater 1:99 (2020); M. S. Ziegler, and J. E. Trancik, Energ Environ Sci, 14, 1635-1651 (2021); P. Greim, et al., Nature Communications 11, 4570 (2020); A. Kumar, et al., Acs Energy Lett 4, 1471-1474 (2019); S. E. C. Sener et al., Acs Sustain Chem Eng 9, 11616-11634 (2021); R. M. DuChanois, et al., Nature Water 1, 37-46 (2023)).

The conventional strategy to extract lithium from aqueous sources relies on pre-concentration via solar evaporation, followed by a series of chemical-based purification and precipitation steps. Lithium extraction is currently geographically limited to arid regions with ample land, requires long processing times, has adverse environmental impacts on chemical and freshwater consumption, and suffers from low lithium recovery rates. The development of direct lithium extraction (DLE) technologies—which are capable of circumventing time- and land-intensive pre-concentration steps, and that can attain high purity lithium without the need for chemical based post-treatment steps—has therefore been extensively studied in recent years. While ion-exchange resins and adsorbents have been highly investigated for lithium extraction, such methods still require partial pre-concentration of lithium due to their limited lithium selectivity over competing cations and necessitate large volumes of freshwater or chemicals to regenerate.

Thus, there is a need in the art for improved electrodialysis systems and methods. This invention satisfies this unmet need.

### SUMMARY OF THE INVENTION

In one aspect, the present invention relates to an electrodialysis system, comprising: a first chamber comprising a first chamber input and a first chamber output; a first set of second and third chambers, wherein the second chamber comprises a second chamber input and a second chamber output, the third chamber comprises a third chamber input and a third chamber output, wherein the first chamber is electrically connected to an anode, and the third chamber is electrically connected to a cathode; a first semipermeable membrane positioned between the first and second chambers and configured to allow ions to flow from the second chamber through the first semipermeable membrane and into the first chamber; a solid-state electrolyte positioned between the second and third chambers and configured to allow ions to flow from the second chamber through the solid-state electrolyte and into the third chamber; a feed channel having a feed channel inlet and a feed channel outlet, wherein the feed channel outlet is fluidly connected to the second chamber input and wherein the feed channel inlet is fluidly connected to the second chamber output; a recovery channel having a recovery channel inlet and a recovery channel outlet, wherein the recovery channel outlet is fluidly connected to the first chamber input and the third chamber input and wherein the recovery channel inlet is fluidly connected to the first chamber output and the third chamber output; and a sample port fluidly connected to the recovery channel.

In one embodiment, the system further comprises a concentrator fluidly connected to the recovery channel. In one embodiment, the concentrator is fluidly connected to the feed channel. In one embodiment, the system further comprises a carbon dioxide channel fluidly connected to the recovery channel. In one embodiment, the concentrator is fluidly connected to the recovery channel downstream of the carbon dioxide channel. In one embodiment, the system further comprises a second set of second and third chambers positioned between the first semipermeable membrane and first set of second and third chambers.

In one embodiment, the semipermeable membrane is selected from the group consisting of a solid-state electrolyte, a bipolar membrane, a cation exchange membrane, and an anion exchange membrane. In one embodiment, the solid-state electrolyte is a sodium super ionic conducting solid-state electrolyte or a lithium super ionic conducting solid state electrolyte. In one embodiment, the solid-state electrolyte has a lithium/magnesium selectivity factor of at least 100. In one embodiment, the solid-state electrolyte has a lithium/sodium selectivity factor of at least 100.

In another aspect, the present invention relates to a method of purifying an ion in a solution, the method comprising the steps of: providing a feed solution comprising an ion; contacting the feed solution with a solid-state electrolyte; applying a current to the solid-state electrolyte such that the ion passes through the solid-state electrolyte to create a recovery solution comprising the ion; and collecting the ion. In one embodiment, the step of applying a current to the solid-state electrolyte such that the ion passes through the solid-state electrolyte to create a recovery solution further comprises the step of recirculating the feed solution such that it contacts the solid-state electrolyte again.

In one embodiment, the step of applying a current to the solid-state electrolyte such that the ion passes through the solid-state electrolyte to create a recovery solution further comprises the step of passing the recovery solution to a concentrator. In one embodiment, the step of passing the recovery solution to a concentrator further comprises the step of adding a salt to the concentrator to induce precipitation of the ion. In one embodiment, the step of applying a current to the solid-state electrolyte such that the ion passes through the solid-state electrolyte to create a recovery solution further comprises the step of contacting the recovery solution with a semipermeable membrane in the presence of the current. In one embodiment, the step of applying a current to the solid-state electrolyte such that the ion passes through the solid-state electrolyte to create a recovery solution further comprises the step of contacting the recovery solution with carbon dioxide.

In one embodiment, the feed solution comprising an ion is aqueous. In one embodiment, the pH of the feed solution comprising an ion is between 2 and 6. In one embodiment, the ion in the feed solution comprising an ion is lithium. In one embodiment, the solid-state electrolyte in the method is a sodium super ionic conducting solid-state electrolyte or a lithium super ionic conducting solid state electrolyte.

### BRIEF DESCRIPTION OF THE DRAWINGS

The following detailed description of embodiments of the invention will be better understood when read in conjunction with the appended drawings. It should be understood that the invention is not limited to the precise arrangements and instrumentalities of the embodiments shown in the drawings.

FIG. 1, comprising FIGS. 1A through FIG. 1D, depicts an investigation of ion and water transport in the solid-state electrolyte (SSE). FIG. 1A depicts the crystalline lattice of the Sodium Super Ionic Conductor (NASICON)-like SSE material utilized throughout this study, as visualized in VESTA (crystal structure viewing software). FIG. 1B depicts the process schematic of the batch electrodialysis (ED) setup used to evaluate ion transport under an applied electric field. The feed and receiving solutions flow across the SSE or cation exchange membrane (CEM) via the inner flow channels, while the external flow channels serve as electrode rinse compartments. The feed and receiving solutions remained hydraulically disconnected, whereas a single electrode rinse solution was recirculated through both electrode rinse chambers. FIG. 1C depicts results from a lithium-ion mass balance experiments in batch ED sets using the SSE. The change in the amount of lithium (Δm_{Li}) in the feed and receiving solution was monitored while a constant 4 V potential was applied for three hours. The feed and receiving solutions initially consisted of 10 mM LiCl and 10 mM KCl, respectively. FIG. 1D depicts a chart with the effect of feed solution lithium concentration on the lithium flux for the SSE and cation exchange membrane (CEM). In each of the experiments, the receiving solution was 10 mM KCl, while the concentration of LiCl in the feed solution was varied. A constant potential of 4 V was applied throughout each experiment. Based on the flux response from both types of membranes, the feed concentration range is broken into two transport regimes, where the lithium flux is either solution concentration limited or membrane transport limited. FIG. 1E depicts a chart with an assessment of water transport across the SSE and CEM in a diffusion cell. The feed chamber consisted of deionized water and the receiving chamber consisted of 500 mM sucrose.

FIG. 2, comprising FIG. 2A and FIG. 2B, depicts diffusion experiments with the SSE. FIG. 2A depicts a schematic showing the experimental configuration. The electrodialysis cell was utilized but no electric potential was applied. The feed and receiving solutions were 0.5 mol L⁻¹ LiCl and deionized water, respectively. A 0.5 mol L⁻¹ MgSO₄ solution was circulated through the electrode rinse compartments. All solutions were pumped at a flowrate of 1 mL min⁻¹. FIG. 2B depicts a chart with lithium and magnesium concentrations in the receiving solution over three hours. Lithium ions did not pass through the SSE, while magnesium ions diffused through the anion exchange membrane (AEM).

FIG. 3, comprising FIGS. 3A through 3C, depicts a design of the custom-built electrodialysis flow-cell utilized to assess the SSE and CEM performance. FIG. 3A depicts an illustration of the design and components of the custom-built electrodialysis flow cell utilized to assess SSE performance. The feed and receiving solutions flow across the SSE via the serpentine inner flow channels, while the external flow channels serve as electrode rinse compartments. FIG. 3B depicts a side profile of the cell showing the stacked components. The stack consists of serpentine flow paths that pass along the central membrane and open square flow channels for the electrode rinse solutions. Ethylene propylene diene monomer (EPDM) gaskets are used to seal the individual components together. The potentiostat leads are connected to the titanium rods which extend from the platinum coated titanium electrodes. FIG. 1C depicts an alternate angle showing the face of the cell, through which the platinum coated titanium mesh electrode can be viewed.

FIG. 4 depicts a chart with concentrations in receiving solution over an electrodialysis experiment using the SSE. The lithium, magnesium, and potassium concentrations in the receiving solution over a three-hour electrodialysis experiment conducted at a constant potential of 4V. The feed solution was 10 mM LiCl, the receiving solution was 10 mM KCl, and the electrode rinse solution was 10 mM MgSO₄.

FIG. 5 depicts a chart with results from water uptake experiments performed using fragments of the SSE. Four replicates were performed with various SSE fragments, and the mass of the fragment was measured before and after soaking in deionized water for two days.

FIG. 6 depicts an experimental setup for evaluating transmembrane water transport. A membrane coupon (either SSE or CEM) is clamped between two 60 mL solution compartments. One compartment was filled with an aqueous solution of 0.5 mol L⁻¹ sucrose, while the other solution was filled with deionized water. The level on the syringe attached to the sucrose solution compartment was monitored to determine the transfer of water across the membrane.

FIG. 7, comprising FIG. 7A through FIG. 7D, depicts plots with data showing the measured membrane potential drop as a function of the applied current for determination of membrane resistance. Data in FIG. 7A and FIG. 7B are replicates for the CEM. Data in FIG. 7C and FIG. 7D are replicates for the SSE. The points represent the potential drop measured across the membrane, and the dashed line shows the linear fit of each data set. The fitting parameters (i.e., slope and intercept) are shown in the table within each plot. The slope of the line is equal to the membrane resistance. The experiments were conducted in the custom-built electrodialysis cells with Luggin capillaries.

FIG. 8 depicts a photograph of the custom-built electrodialysis flow-cell utilized to measure the conductivity and energy barriers of the SSE and CEM. The inner flow channels in the more compact ED flow cell were replaced with thicker flow channels carved into acrylic plates. Luggin capillaries were inserted into the acrylic plates through compression fittings, and the capillary tips were oriented to be close to the central membrane surface, without making direct contact. The Luggin capillaries were filled with 0.5 M KCl and Ag/AgCl reference electrodes were placed in each capillary to measure the potential difference across the central membrane. Varying temperature studies were performed by submerging all solutions and the cell (up the height of the titanium rods) in a water bath (with continuous recirculation of the heated water).

FIG. 9, comprising FIG. 9A through FIG. 9D, depicts fundamental transport differences between an SSE and CEM. FIG. 9A depicts a chart withs comparisons of membrane conductivity and free energy barrier for the CEM and SSE. The conductivity values shown were obtained by measuring the potential difference across the membrane at various applied current densities at room-temperature. Free energy barriers for lithium transport were determined through the measurement of membrane conductivity at various temperatures. FIG. 9B depicts a chart with the enthalpic and entropic contributions to the free energy barrier for the CEM and SSE. FIG. 9C depicts the free energy coordinate for the CEM as lithium ions are transported from the feed side, through the membrane, and into the receiving solution. FIG. 9D depicts the free energy coordinate for the SSE as lithium ions are transported from the feed side, through the membrane, and into the receiving solution.

FIG. 10, comprising FIG. 10A through FIG. 10D, depicts Arrhenius plots for the determination of energy barriers. Data in FIG. 10A and FIG. 10B are replicates for the CEM. Data in FIG. 10C and FIG. 10D are replicates for the SSE. The points show the natural logarithm of the measured membrane conductivity (Om) multiplied by the membrane specific lumped parameter (a). The membrane conductivity was measured at various temperatures ranging from 25° C. to 40° C. The dashed line shows the linear fit of each data set. The fitting parameters (i.e., slope and intercept) are shown in the table within each plot.

FIG. 11 depicts a chart with the measured concentrations of lithium in the leaching experiments performed with the SSE. The SSE was immersed in deionized water for one week. Ion chromatography was unable to detect any lithium ions in solution over the entire period.

FIG. 12, comprising FIGS. 12A through 12D, depicts an assessment of ion-ion selectivity in the SSE. FIG. 12A depicts a chart with current response from linearly sweeping the potential at a scan rate of 2 mV s⁻¹. A 100 mM single-salt solution of either lithium chloride, sodium chloride, or magnesium chloride was utilized and continuously recirculated through both the feed and receiving channels. The inset shows the current density on a truncated scale to more clearly show the data and trends in the low-current regime. FIG. 12B depicts a chart with lithium and sodium concentrations in the receiving solution over a fifty-hour long-term ion competition experiment. A multi-salt feed solution of 10 mM LiCl and 10 mM NaCl was continuously supplied to the feed channel over the experiment duration, while the receiving solution was initially 10 mM KCl. The dashed line shows the linear fit of the lithium concentration data. FIG. 12C depicts a chart with results from multi-salt ion competition experiments in which the feed solution consisted of varying molar ratios of either Na: Li or Mg: Li. The lithium flux for each of the experiments is shown, while the sodium and magnesium fluxes remained undetectable across all experimental conditions. FIG. 12D depicts a chart showing the effect of feed solution pH on the lithium flux. The pH of a 10 mM LiCl solution was adjusted by dosing either hydrochloric acid or lithium hydroxide.

FIG. 13 depicts a chart with the effect of pH adjustment with lithium hydroxide on lithium flux. The lithium flux across the SSE as a function of the feed lithium concentration is shown. The circle points are taken from the SSE data presented in FIG. 1E. A power law fitting is applied to these points as shown by the dashed line and equation in the plot. The experimentally obtained lithium flux for the experiments conducted at pH 11 (pH was adjusted with LiOH) is shown by the blue triangle, showing good fit with the expected flux increase.

FIG. 14 depicts a chart with the pH of the receiving solution over the duration of the SSE electrodialysis experiments conducted at pH 2 (bottom lines) and pH 3.7 (top lines). Each line shows a different replicate. The feed solution was 10 mM LiCl, the receiving solution was 10 mM KCl, and the electrode rinse solution was 10 mM MgSO₄. The pH of the feed solution was adjusted by dosing HCl.

FIG. 15, comprising FIG. 15A through FIG. 15C depicts molecular dynamics snapshots captured at the end of the simulation period for three systems analyzed. In each simulation box, a LiTi₂(PO₄)₃ membrane was placed between two aqueous solutions. The simulations were initialized with the right-hand side solution containing pure water, while the solution on the left-hand side contained salt ions. Each system initially contained the same number of lithium ions (green spheres) in the left-hand solution. FIG. 15A depicts a snapshot of a system where only lithium chloride was in the left-hand solution. FIG. 15B depicts a snapshot of a system where lithium ions matched the amount of sodium ions in the left-hand solution. FIG. 15C depicts a snapshot of a system where lithium ions matched the amount of magnesium ions in the left-hand solution.

FIG. 16 depicts water molecule exclusion by the SSE from molecular dynamics simulations. Snapshot at the end of the molecular dynamics simulation showing only water molecules and the SSE structure. No water molecules exist within the SSE structure.

FIG. 17 depicts anhydrous transport of lithium ion through the SSE structure from molecular dynamics simulation. Snapshot at the end of the molecular dynamics simulation showing a single lithium ion (largest sphere) transporting through the SSE structure. For clarity, other lithium ions are not shown. As the lithium ion traverses the SSE, it forms coordination bonds with oxygen atoms within the SSE.

FIG. 18 depicts a chart with molecular dynamics simulation results showing the fraction of the total ion content made up of the competing ion (i.e., sodium or magnesium) at various positions along the length of the simulated SSE membrane. The triangles with a line indicate the results from the simulated system containing lithium and sodium in the feed solution, while the circles and line show the data from the simulation where lithium and magnesium ions were in the feed solution. Only the sodium and magnesium ion fraction are shown while the remainder of the content is made up of lithium ions.

FIG. 19 depicts a visualization of PoreBlazer simulations performed with various diameter spherical probes (d_{probe}). The LiTi₂(PO₄)₃ unit cell is overlayed with spheres which indicate accessible positions for the probe.

FIG. 20 depicts a chart with PoreBlazer simulation results showing the accessible volume of a LiTi₂(PO₄)₃ unit cell for various sized probes. The results correspond to the visual representation in FIG. 19.

FIG. 21 depicts the hydration state of ions in bulk solution from molecular dynamics simulation. The water molecules which exist within the expected hydrated diameter of each ion (according to Table 1) are shown.

FIG. 22 depicts scanning electron microscopy-energy dispersive x-ray spectroscopy (SEM-EDS) images of the SSE cross section after use in a 48-hour experiment with 10 mM NaCl and 10 mM LiCl feedwater. Elemental maps of sodium, silicon, germanium, and oxygen are shown in separate panels.

FIG. 23 depicts x-ray diffraction (XRD) patterns of the SSE. The pristine line shows the diffraction pattern for the SSE before being used in any experiments, while the Na exposed line indicates the diffraction pattern for the SSE after it had been utilized in a long-term multi-salt electrodialysis experiment in which the feed solution consisted of 10 mM LiCl and 10 mM NaCl. The arrows shown highlight differences between the two diffraction patterns. Na₄P₂O₇: JCPDS No. 10-0187. Li₄P₂O₇: JCPDS No. 01-087-0409. LiTi₂P₃O₁₂: JCPDS No. 35-0754. AlPO₄: JCPDS No. 04-015-7509.

FIG. 24, comprising FIG. 24A and FIG. 24B, depict charts highlighting comparisons of the SSE to other reported lithium ion selective membranes. FIG. 24A depicts a chart with the lithium-magnesium selectivity ratio and the lithium ion flux for various membranes in the literature. The reported performance for the SSE corresponds to the experiments performed with a Mg: Li molar ratio of 10:1. FIG. 24B depicts a chart with the specific energy consumptions (SEC) of lithium extraction using the SSE as compared to pressure driven nanofiltration membranes. The SEC values for the layer-by-layer (LbL) NF membrane and highly selective polyamide (PA) NF membrane were calculated based on the conditions reported in the respective works. For each of the SEC values, the feed solution is a binary mixture containing approximately a 10:1 molar ratio of Mg: Li. Arrows are provided to indicate the points in FIG. 24A which correspond to the evaluated NF membranes in FIG. 24B.

FIG. 25 depicts a chart with a calibration curve of magnesium on a Nexion 5000 inductively coupled plasma mass spectrometry (ICP-MS). The calibration standards consisted of various parts-per billion concentrations of magnesium ranging from 0.1 ppb to 100 ppb, and were prepared with a background concentration of 10 ppm potassium and 0.5 ppm lithium to closely match the matrix of tested samples from the competitive ion transport experiments. A linear fit of the data is shown, indicating excellent quantification of magnesium ions down to concentrations <0.1 ppb. For the purpose of providing an approximate selectivity value of the SSE for comparison, 0.1 ppb was utilized as the limit of detection of the ICP-MS (and was subsequently scaled by the dilution factor of sample preparation).

FIG. 26 depicts an illustration of an exemplary solid-state electrolyte electrodialysis crystallization process for lithium recovery.

FIG. 27 depicts an illustration of an exemplary solid-state electrolyte bipolar membrane electrodialysis crystallization process for lithium recovery.

FIG. 28 depicts an illustration of an exemplary solid-state electrolyte bipolar membrane electrodialysis crystallization process for lithium recovery with integrated carbon capture.

FIG. 29 depicts a block diagram of an exemplary electrodialysis system 100.

### DETAILED DESCRIPTION

The present invention relates in part to an electrodialysis system comprising a semipermeable membrane and a solid-state electrolyte. The highly ordered solid-state electrolyte lattice provides unique membrane properties which are utilized for lithium separation and extraction. The solid-state electrolyte is highly selective against competing ions and stable under aqueous conditions.

It is to be understood that the Figures and descriptions of the present invention have been simplified to illustrate elements that are relevant for a clear understanding of the present invention, while eliminating, for the purpose of clarity, many other elements used the invention. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of +20%, +10%, +5%, +1%, or +0.1% from the specified value, as such variations are appropriate to perform the disclosed methods.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

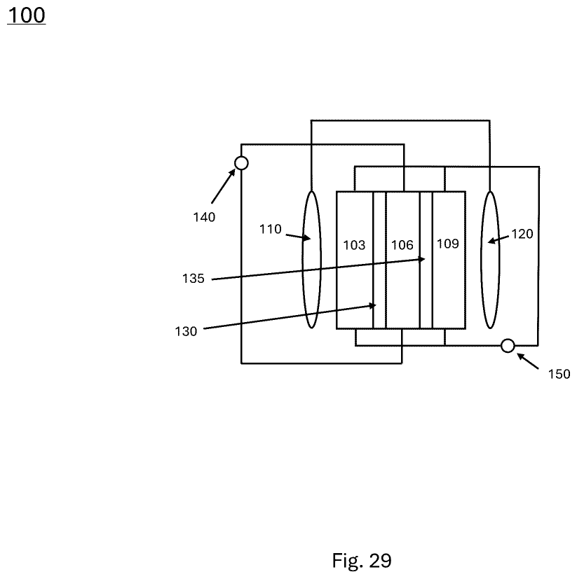

Electrodialysis System As shown in FIG. 29, the present invention relates in part to an electrodialysis system 100 comprising a first chamber 103 comprising a first chamber input and first chamber output; a first set of second 106 and third 109 chambers, wherein the second chamber comprises a second chamber input and a second chamber output, the third chamber comprises a third chamber input and a third chamber output, wherein the first chamber is electrically connected to an anode 110, and the third chamber is electrically connected to a cathode 120; a first semipermeable membrane 130 positioned between the first and second chambers and configured to allow ions to flow from the second chamber through the first semipermeable membrane and into the first chamber; a solid state electrolyte 135 positioned between the second and third chambers and configured to allow ions to flow from the second chamber through the solid-state electrolyte and into the third chamber; a feed channel 140 having a feed channel inlet and a feed channel outlet, wherein the feed channel outlet is fluidly connected to the second chamber input and wherein the feed channel inlet is fluidly connected to the second chamber output; and a recovery channel 150 having a recovery channel inlet and a recovery channel outlet, wherein the recovery channel outlet is fluidly connected to the first chamber input and the third chamber input and wherein the recovery channel inlet is fluidly connected to the first chamber output and the third chamber output; and a sample port fluidly connected to the recovery channel.

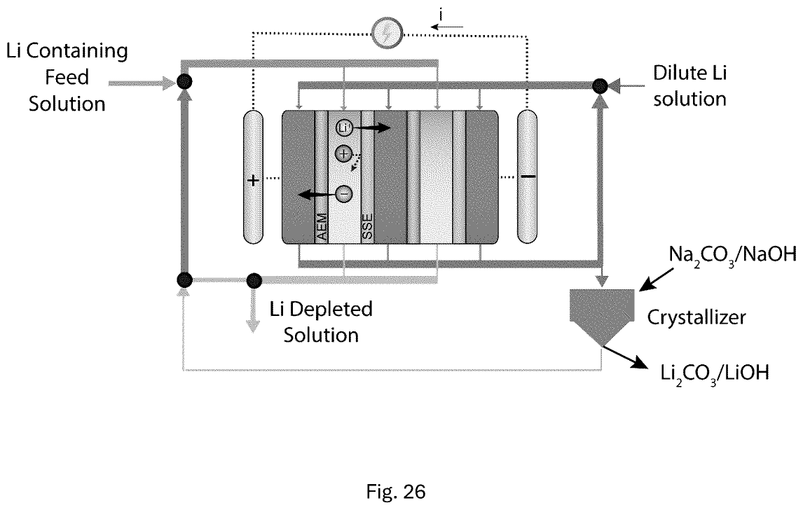

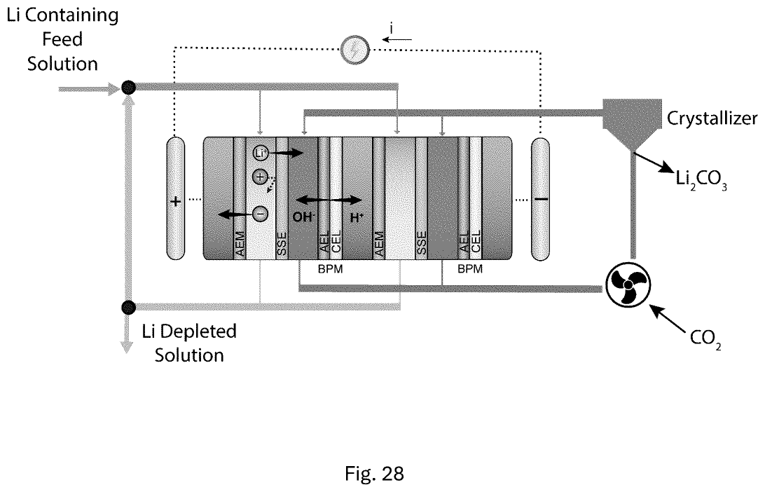

In some embodiments, as shown in FIG. 26, the system further comprises a concentrator fluidly connected to the recovery channel. In some embodiments, the concentrator is a crystallizer. In some embodiments, the concentrator is fluidly connected to the feed channel. In some embodiments, as shown in FIG. 26, the system further comprises a second set of second and third chamber positioned between the first semipermeable membrane and first set of second and third chambers, in this instance, the system would comprise at least two sets of second and third chambers. In some embodiments, as shown in FIG. 26, the system comprises more than one set of second and third chambers. In some embodiments, the system comprises more than two sets of second and third chambers. In some embodiments, the system comprises more than ten sets of second and third chambers. In some embodiments, the system comprises more than fifty sets of second and third chambers. In some embodiments, the system comprises more than one hundred sets of second and third chambers. In some embodiments, as shown in FIG. 28, the system further comprises a carbon dioxide channel fluidly connected to the recovery channel. The carbon dioxide channel may aid in feeding carbon dioxide gas into to the system. In some embodiments, the carbon dioxide channel is a carbon dioxide contactor. The carbon dioxide contactor may aid in contacting carbon dioxide with sample fed into the system. In some embodiments, as shown in FIG. 26, the system further comprises a dilute solution channel fluidly connected to the recovery channel.

In some embodiments, the electrodialysis system comprises a semi-permeable membrane. Examples of semi-permeable membranes include but are not limited to, solid-state electrolytes, bipolar membranes, selective ion exchange membranes, cation exchange membranes, anion exchange membranes, reverse osmosis membranes, forward osmosis membranes, nanofiltration membranes, semi-transparent membranes, ultrafiltration membranes, monovalent-selective ion exchange membranes, divalent-selective ion exchange membranes, alkaline anion exchange membranes, proton exchange membranes, polyelectrolyte multilayer films, metal organic frameworks, and covalent organic frameworks. In some embodiments, the bipolar membrane comprises a cation exchange layer and an anion exchange layer. In some embodiments, the system further comprises a bipolar membrane positioned between the third chamber and a fourth chamber positioned between the third chamber and the cathode, and configured to allow ions to flow from the third chamber into the fourth chamber. In some embodiments, the fourth chamber is electrically connected to the cathode.

In some embodiments, the electrodialysis system comprises a solid-state electrolyte. Examples of solid-state electrolytes (SSEs) include but are not limited to Sodium Super Ionic Conductor (NASICON) type SSEs, Li Super Ionic Conductor (LISICON) type SSEs, argyrodite type SSEs, halide-free argyrodite type SSEs, garnet type SSEs, perovskite type SSEs, lithium phosphorus sulfur (LPS) type SSEs, lithium germanium phosphorus sulfur (LGPS) type SSEs, lithium aluminum germanium phosphate (LAGP) type SSEs, magnesium germanium phosphate type SSEs, cobalt germanium phosphate type SSEs, copper germanium phosphate type SSEs, strontium germanium phosphate type SSEs, lithium aluminum titanium phosphorus (LATP) type SSEs, tantalum doped lithium lanthanum zirconate (Ta-doped LLZO) type SSEs, lithium phosphorus oxynitride (LiPON) type SSEs, and niobium doped lithium lanthanum zirconate (Nb-doped LLZO, LLZNO) type SSEs. In some embodiments, the SSE has a high lithium-ion conductivity. In some embodiments, the SSE is of general formulas such as Mg_{0.5+x}Ge₂₋ₓ(PO₄)₃. Co_{0.5+x}Ge₂₋ₓ(PO₄)₃, Cu_{0.5+x}Ge₂₋ₓ(PO₄)₃, and Sr_{0.5+x}Ge₂₋ₓ(PO₄)₃. In some embodiments, the SSE has a high water stability.

In some embodiments, the SSE has a high selectivity for lithium ions over other ions such as sodium and magnesium. In some embodiments, the SSE has a lithium/magnesium selectivity factor of at least 2. In some embodiments, the SSE has a lithium/magnesium selectivity factor of at least 5. In some embodiments, the SSE has a lithium/magnesium selectivity factor of at least 10. In some embodiments, the SSE has a lithium/magnesium selectivity factor of at least 25. In some embodiments, the SSE has a lithium/magnesium selectivity factor of at least 50. In some embodiments, the SSE has a lithium/magnesium selectivity factor of at least 100. In some embodiments, the SSE has a lithium/magnesium selectivity factor of at least 500. In some embodiments, the SSE has a lithium/magnesium selectivity factor of at least 1,000. In some embodiments, the SSE has a lithium/magnesium selectivity factor of at least 2,500. In some embodiments, the SSE has a lithium/magnesium selectivity factor of at least 5,000. In some embodiments, the SSE has a lithium/magnesium selectivity factor of at least 10,000. In some embodiments, the SSE has a lithium/magnesium selectivity factor of at least 20,000. In some embodiments, the SSE has a lithium/magnesium selectivity factor of at least 25,000. In some embodiments, the SSE has a lithium/magnesium selectivity factor of about 24,000. In some embodiments, the SSE has a lithium/magnesium selectivity factor of about 25,000. In some embodiments, the SSE has a lithium/magnesium selectivity factor of about 26,000. In some embodiments, the SSE has a lithium/magnesium selectivity factor of about 27,000.

In some embodiments, the SSE has a lithium/sodium selectivity factor of at least 2. In some embodiments, the SSE has a lithium/sodium selectivity factor of at least 5. In some embodiments, the SSE has a lithium/sodium selectivity factor of at least 10. In some embodiments, the SSE has a lithium/sodium selectivity factor of at least 25. In some embodiments, the SSE has a lithium/sodium selectivity factor of at least 50. In some embodiments, the SSE has a lithium/sodium selectivity factor of at least 100. In some embodiments, the SSE has a lithium/sodium selectivity factor of at least 500. In some embodiments, the SSE has a lithium/sodium selectivity factor of at least 1,000. of In some embodiments, the SSE has a lithium/sodium selectivity factor of at least 5,000. In some embodiments, the SSE has a lithium/sodium selectivity factor of at least 10,000. In some embodiments, the SSE has a lithium/sodium selectivity factor of at least 20,000. In some embodiments, the SSE has a lithium/sodium selectivity factor of at least 25,000. In some embodiments, the SSE has a lithium/sodium selectivity factor of about 24,000. In some embodiments, the SSE has a lithium/sodium selectivity factor of about 25,000. In some embodiments, the SSE has a lithium/sodium selectivity factor of about 26,000. In some embodiments, the SSE has a lithium/sodium selectivity factor of about 27,000.

In some embodiments, the electrodialysis system comprises an anode and a cathode. In some embodiments, the anode and cathode comprise electrodes made of or coated with metals including, but not limited to zinc, cobalt, copper, magnesium, silver, iron, platinum, graphite, titanium, brass, lead, steel, nickel, ruthenium, iridium, and the like. In some embodiments, the electrodialysis system comprises non-metal electrodes such as hydrogen electrodes, chlorine electrodes, oxygen electrodes, and the like.

In some embodiments, the system further comprises spacer materials to promote turbulence and mixing within the any one of the first, second, and third chambers. Spacer materials include, but are not limited to meshes, diffusors, gaskets, ion-exchange resins, other porous materials, and the like. In one embodiment, the electrodialysis system comprises a first electrode rinse chamber positioned between the anode and the first semipermeable membrane and a second electrode rinse chamber positioned between the solid-state electrolyte and the cathode. In some embodiments, the electrodialysis system comprises a power supply or a potentiostat with leads. In some embodiments, a metal rod or other electronic conductor is pushed against the electrodes to ensure connection between the potentiated leads and the electrodes.

### Method of Extraction

In one aspect, the present invention relates to a method of purifying an ion in a solution, the method comprising the steps of: providing a feed solution comprising an ion, contacting the solution with a solid-state electrolyte, applying a current to the solid-state electrolyte such that the ion passes through the solid-state electrolyte to create a recovery solution comprising the ion; and collecting the ion.

Examples of solid-state electrolytes are described above. In some embodiments, the method further comprises the step of contacting the recovery solution with a second solid-state electrolyte in the presence of a current such that the ion passes through the second solid-state electrolyte and increases the purity of the ion. In some embodiments, the recovery solution is contacted with more than one solid-state electrolyte in the presence of a current, such that ion passes through each solid-state electrolyte, and purity of the ion increases each time the ion passes through a solid-state electrolyte. In some embodiments, the recovery solution is contacted with more than ten solid-state electrolytes. In some embodiments, the recovery solution is contacted with more than fifty solid-state electrolytes. In some embodiments, the recovery solution is contacted with more than one hundred solid-state electrolytes. In some embodiments, the recovery solution is circulated through a series of solid-state electrolytes.

In some embodiments, the feed solution is a fluid which comprises seawater, oil extraction waste, brine, mining influence water, groundwater, brackish water, freshwater, wastewater, fluids rich in lithium, or recirculated water from any one of the channels in the system. In some embodiments, the feed solution is aqueous. In some embodiments the feed solution is acidic. In some embodiments, the feed solution has a pH less than 13. In some embodiments, the feed solution has a pH less than 12. In some embodiments, the feed solution has a pH less than 11. In some embodiments, the feed solution has a pH less than 10. In some embodiments, the feed solution has a pH less than 9. In some embodiments, the feed solution has a pH less than 8. In some embodiments, the feed solution has a pH less than 7. In some embodiments, the feed solution has a pH less than 6. In some embodiments, the feed solution has a pH less than 5. In some embodiments, the feed solution has a pH less than 4. In some embodiments, the feed solution has a pH less than 3. In some embodiments, the feed solution has a pH between 2 and 11. In some embodiments, the feed solution has a pH between 2 and 10. In some embodiments, the feed solution has a pH between 2 and 9. In some embodiments, the feed solution has a pH between 2 and 8. In some embodiments, the feed solution has a pH between 2 and 7. In some embodiments, the feed solution has a pH between 2 and 6. In some embodiments, the feed solution has a pH between 2 and 5. In some embodiments, the feed solution has a pH between 2 and 4. In some embodiments, the feed solution has a pH between 7 and 13. In some embodiments, the feed solution has a pH between 8 and 12. In some embodiments, the feed solution has a pH between 9 and 11. In some embodiments, the feed solution is nonaqueous. In some embodiments, the feed solution has a pH of about 2. In some embodiments, the feed solution has a pH of about 4. In some embodiments, the feed solution has a pH of about 6. In some embodiments, the feed solution has a pH of about 4. In some embodiments, the feed solution has a pH of about 8. In some embodiments, the feed solution has a pH of about 10. In some embodiments, the feed solution has a pH of about 8. In some embodiments, the feed solution has a pH of about 12.

The feed solution may comprise any type of ion. Exemplary ions include but are not limited to calcium, hydrogen, hydroxide, aluminum, magnesium, sodium, potassium, lithium, strontium, barium, ammonia, carbonate, sulfate, chloride, cobalt, copper, neodymium, dysprosium, gallium, iridium, terbium, nitrate, boron, silicon dioxide, and iron. In some embodiments, the feed solution comprises salts including, but not limited to, sodium chloride (NaCl), lithium hydroxide (LiOH), lithium chloride (LiCl), potassium chloride (KCl), magnesium chloride (MgCl₂), magnesium carbonate (MgCO₃), magnesium sulfate (MgSO₄), calcium chloride (CaCl₂)), calcium sulfate (CaSO₄), calcium carbonate (CaCO₃), potassium acetate (KAc) and calcium magnesium acetate (CaMgAc). In some embodiments, the feed solution comprises water.

In some embodiments, the feed solution comprises lithium chloride. In some embodiments, the concentration of lithium chloride in the feed solution is between 0.1 mM and 10,000 mM. In some embodiments, the concentration of lithium chloride in the feed solution is between 0.1 mM and 10,000 mM. In some embodiments, the concentration of lithium chloride in the feed solution is between 1 mM and 5000 mM. In some embodiments, the concentration of lithium chloride in the feed solution is between 2 mM and 1000 mM. In some embodiments, the concentration of lithium chloride in the feed solution is between 3 mM and 500 mM. In some embodiments, the concentration of lithium chloride in the feed solution is between 4 mM and 100 mM. In some embodiments, the concentration of lithium chloride in the feed solution is between 5 mM and 50 mM. In some embodiments, the concentration of lithium chloride in the feed solution is between 6 mM and 40 mM. In some embodiments, the concentration of lithium chloride in the feed solution is between 7 mM and 30 mM.

In some embodiments, the concentration of lithium chloride in the feed solution is greater than 0.1 mM. In some embodiments, the concentration of lithium chloride in the feed solution is greater than 0.5 mM. In some embodiments, the concentration of lithium chloride in the feed solution is greater than 1 mM. In some embodiments, the concentration of lithium chloride in the feed solution is greater than 5 mM. In some embodiments, the concentration of lithium chloride in the feed solution is greater than 10 mM. In some embodiments, the concentration of lithium chloride in the feed solution is greater than 25 mM. In some embodiments, the concentration of lithium chloride in the feed solution is greater than 100 mM. In some embodiments, the concentration of lithium chloride in the feed solution is greater than 500 mM. In some embodiments, the concentration of lithium chloride in the feed solution is greater than 1000 mM. In some embodiments, the concentration of lithium chloride in the feed solution is less than 0.1 mM. In some embodiments, the concentration of lithium chloride in the feed solution is less than 0.5 mM. In some embodiments, the concentration of lithium chloride in the feed solution is less than 1 mM. In some embodiments, the concentration of lithium chloride in the feed solution is greater less 5 mM. In some embodiments, the concentration of lithium chloride in the feed solution is less than 10 mM. In some embodiments, the concentration of lithium chloride in the feed solution is less than 25 mM. In some embodiments, the concentration of lithium chloride in the feed solution is less than 100 mM. In some embodiments, the concentration of lithium chloride in the feed solution is less than 500 mM. In some embodiments, the concentration of lithium chloride in the feed solution is less than 1000 mM.

In some embodiments, the feed solution comprises sodium chloride. In some embodiments, the concentration of sodium chloride in the feed solution is between 0.1 mM and 10,000 mM. In some embodiments, the concentration of sodium chloride in the feed solution is between 0.1 mM and 10,000 mM. In some embodiments, the concentration of sodium chloride in the feed solution is between 1 mM and 5000 mM. In some embodiments, the concentration of sodium chloride in the feed solution is between 2 mM and 1000 mM. In some embodiments, the concentration of sodium chloride in the feed solution is between 3 mM and 500 mM. In some embodiments, the concentration of sodium chloride in the feed solution is between 4 mM and 100 mM. In some embodiments, the concentration of sodium chloride in the feed solution is between 5 mM and 50 mM. In some embodiments, the concentration of sodium chloride in the feed solution is between 6 mM and 40 mM. In some embodiments, the concentration of sodium chloride in the feed solution is between 7 mM and 30 mM.

In some embodiments, the concentration of sodium chloride in the feed solution is greater than 0.1 mM. In some embodiments, the concentration of sodium chloride in the feed solution is greater than 0.5 mM. In some embodiments, the concentration of sodium chloride in the feed solution is greater than 1 mM. In some embodiments, the concentration of sodium chloride in the feed solution is greater than 5 mM. In some embodiments, the concentration of sodium chloride in the feed solution is greater than 10 mM. In some embodiments, the concentration of sodium chloride in the feed solution is greater than 25 mM. In some embodiments, the concentration of sodium chloride in the feed solution is greater than 100 mM. In some embodiments, the concentration of sodium chloride in the feed solution is greater than 500 mM. In some embodiments, the concentration of sodium chloride in the feed solution is greater than 1000 mM.

In some embodiments, the concentration of sodium chloride in the feed solution is less than 0.1 mM. In some embodiments, the concentration of sodium chloride in the feed solution is less than 0.5 mM. In some embodiments, the concentration of sodium chloride in the feed solution is less than 1 mM. In some embodiments, the concentration of sodium chloride in the feed solution is greater less 5 mM. In some embodiments, the concentration of sodium chloride in the feed solution is less than 10 mM. In some embodiments, the concentration of sodium chloride in the feed solution is less than 25 mM. In some embodiments, the concentration of sodium chloride in the feed solution is less than 100 mM. In some embodiments, the concentration of sodium chloride in the feed solution is less than 500 mM. In some embodiments, the concentration of sodium chloride in the feed solution is less than 1000 mM.

In some embodiments, a current is applied to the solid-state electrolytes such that the ion passes through the solid-state electrolyte to create a recovery solution comprising the ion. In some embodiments, the step of applying a current is done with a pair of electrodes. In some embodiments, the current that is applied to the solid-state electrolyte comprises a voltage. In some embodiments, the voltage is between 0.1 V and 15 V. In some embodiments, the voltage is between 1 V and 10 V. In some embodiments, the voltage is between 1 V and 100 V. In some embodiments, the voltage is between 1 V and 10 V. In some embodiments, the voltage is between 1 V and 1 kV. In some embodiments, the voltage is between 1 V and 10 V. In some embodiments, the voltage is between 1 V and 10 kV. In some embodiments, the voltage is between 2 V and 8 V. In some embodiments, the voltage is between 3 V and 6 V. In some embodiments, the voltage is about 2 V. In some embodiments, the voltage is about 3 V. In some embodiments, the voltage is about 4 V. In some embodiments, the voltage is about 5 V. In some embodiments, the voltage is about 6 V. In some embodiments, the voltage is continuous. In some embodiments, the voltage is a pulsating voltage.

In some embodiments, the voltage is greater than 1 V. In some embodiments, the voltage is greater than 2 V. In some embodiments, the voltage is greater than 3 V. In some embodiments, the voltage is greater than 4 V. In some embodiments, the voltage is greater than 5 V. In some embodiments, the voltage is greater than 6 V. In some embodiments, the voltage is greater than 7 V. In some embodiments, the voltage is greater than 8 V. In some embodiments, the voltage is greater than 10 V. In some embodiments, the voltage is greater than 15 V. In some embodiments, the voltage is less than 1 V. In some embodiments, the voltage is less than 2 V. In some embodiments, the voltage is less than 3 V. In some embodiments, the voltage is less than 4 V. In some embodiments, the voltage is less than 5 V. In some embodiments, the voltage is less than 6 V. In some embodiments, the voltage is less than 7 V. In some embodiments, the voltage is greater than 8 V. In some embodiments, the voltage is less than 10 V. In some embodiments, the voltage is greater than 15 V. In some embodiments, the voltage is greater than 100 V. In some embodiments, the voltage is greater than 1 kV. In some embodiments, the voltage is greater than 10 kV.

In some embodiments, the step of applying a current to the solid-state electrolyte creates an electric field. In some embodiments, the electric field has a fixed direction. In some embodiments, the electric field is a dynamic electric field. In some embodiments, the electric field has a direction which can be reversed to help dislodge ions stuck solid-state electrolyte.

In some embodiments, the step of applying a current to the solid-state electrolyte such that the ion passes through the solid-state electrolyte to create a recovery solution comprising the ion further comprises the step of recirculating the feed solution such that it contacts the solid-state electrolyte again. Recirculating the feed solution ensures maximum collection of the ion. In some embodiments, the step of applying a current to the solid-state electrolyte such that the ion passes through the solid-state electrolyte to create a recovery solution comprising the ion, further comprises the step of passing the recovery solution to a concentrator. In some embodiments, the concentrator is an evaporative crystallizer. In some embodiments, the step of passing the recovery solution to a concentrator further comprises the step of adding a salt to the concentrator to induce precipitation of the ion. In some embodiments, salts that are added to the concentrator include, but are not limited to sodium carbonate, potassium carbonate, sodium hydroxide, and potassium hydroxide. In some embodiments, the step of adding a salt to the concentrator further comprises the step of cooling the concentrator to facilitate in precipitation of the ion. In some embodiments, the step of passing the ion to a concentrator creates a concentrator effluent which could be mixed with the feed solution comprising the ion to maximize collection of the ion.

In some embodiments, the step of applying a current to the solid-state electrolyte such that the ion passes through the solid-state electrolyte to create a recovery solution comprising the ion, further comprises the step of contacting the recovery solution with carbon dioxide. In some embodiments, the carbon dioxide that is contacted with the ion is atmospheric. Mixing carbon dioxide with the recovery solution may induce the formation of a carbonate salt comprising the ion to be collected.

In some embodiments, the step of applying a current to the solid-state electrolyte such that the ion passes through the solid-state electrolyte to create a recovery solution comprising the ion, further comprises the step of contacting the recovery solution with a semipermeable membrane. In some embodiments, the step of contacting the recovery solution with a semipermeable membrane is done in the presence of a current, which may cause the splitting of water molecules present in the recovery solution, generating hydroxide ions in the recovery solution. The generation of hydroxide molecules may cause an increase in the pH of the recovery solution. In some embodiments, the step of contacting the recovery solution with a semipermeable membrane in the presence of a current, further comprises the step of contacting the recovery solution with carbon dioxide.

In some embodiments, the pH of the recovery solution is between 8 and 13. In some embodiments, the pH of the recovery solution is between 8 and 12. In some embodiments, the pH of the recovery solution is between 8 and 11. In some embodiments, the pH of the recovery solution is between 8 and 10. In some embodiments, the pH of the recovery solution is between 9 and 13. In some embodiments, the pH of the recovery solution is between 9 and 12. In some embodiments, the pH of the recovery solution is between 9 and 11. In some embodiments, the pH of the recovery solution is between 10 and 13. In some embodiments, the pH of the recovery solution is between 10 and 12. In some embodiments, the pH of the recovery solution is greater than 7. In some embodiments, the pH of the recovery solution is greater than 8. In some embodiments, the pH of the recovery solution is greater than 9. In some embodiments, the pH of the recovery solution is greater than 10. In some embodiments, the pH of the recovery solution is greater than 11. In some embodiments, the pH of the recovery solution is greater than 12. In some embodiments, the pH of the recovery solution is greater than 13.

The method may be operated in any manner desired, e.g. as continuous, batch, semi-batch, semi-continuous. The process may be controlled using known equipment and control schemes. For example, hydraulic retention time, velocity of fluid, mixing of fluid, desired feed rates of feed solution, anti-scalants, etc. may be determined by routine experimentation. In some embodiments, the flow rate in the process is controlled by setting a pump to the desired flow rate.

In some embodiments, the step of inputting a feed solution further comprises the step of setting a desired flow rate through all or part of the system. In one embodiment, the flow rate through part or all of the system is between 0.1 ml/min and 50 ml/min. In one embodiment, the flow rate through part or all of the system is between 0.5 ml/min and 25 ml/min. In one embodiment, the flow rate through part or all of the system is between 0.5 ml/min and 10 ml/min. In one embodiment, the flow rate through part or all of the system is about 0.1 ml/min. In one embodiment, the flow rate through part or all of the system is about 1 ml/min. In one embodiment, the flow rate through part or all of the system is about 10 ml/min. In one embodiment, the flow rate through part or all of the system is about 100 ml/min. In one embodiment, the flow rate through part or all of the system is about 1 L/min. In one embodiment, the flow rate through part or all of the system is about 100 L/min. In one embodiment, the flow rate through part or all of the system is about 1000 L/min. In one embodiment, the flow rate through part or all of the system is about 2000 L/min. Full-scale systems would be operated at high flow rates, such as gallons per minute or equivalent flow rates.

In one embodiment, the flow rate through part or all of the system is greater than 0.1 ml/min. In one embodiment, the flow rate through part or all of the system is greater than 0.5 ml/min. In one embodiment, the flow rate through part or all of the system is greater than 1.0 ml/min. In one embodiment, the flow rate through part or all of the system is greater than 2.0 ml/min. In one embodiment, the flow rate through part or all of the system is greater than 5.0 ml/min. In one embodiment, the flow rate through part or all of the system is greater than 10.0 ml/min. In one embodiment, the flow rate through part or all of the system is greater than 15.0 ml/min. In one embodiment, the flow rate through part or all of the system is greater than 20.0 ml/min. In one embodiment, the flow rate through part or all of the system is greater than 50.0 ml/min. In one embodiment, the flow rate through part or all of the system is greater than 100.0 ml/min. In one embodiment, the flow rate through part or all of the system is greater than 1.0 L/min. In one embodiment, the flow rate through part or all of the system is greater than 500 L/min. In one embodiment, the flow rate through part or all of the system is greater than 1000 L/min. In one embodiment, the flow rate through part or all of the system is greater than 2000 L/min.

In one embodiment, the flow rate through part or all of the system is less than 0.1 ml/min. In one embodiment, the flow rate through part or all of the system is less than 0.5 ml/min. In one embodiment, the flow rate through part or all of the system is less than 1.0 ml/min. In one embodiment, the flow rate through part or all of the system is less than 2.0 ml/min. In one embodiment, the flow rate through part or all of the system is less than 5.0 ml/min. In one embodiment, the flow rate through part or all of the system is less than 10.0 ml/min. In one embodiment, the flow rate through part or all of the system is less than 15.0 ml/min. In one embodiment, the flow rate through part or all of the system is less than 20.0 ml/min. In one embodiment, the flow rate through part or all of the system is less than 50.0 ml/min. In one embodiment, the flow rate through part or all of the system is less than 100.0 ml/min. In one embodiment, the flow rate through part or all of the system is less than 1 L/min. In one embodiment, the flow rate through part or all of the system is less than 10 L/min. In one embodiment, the flow rate through part or all of the system is less than 100 L/min. In one embodiment, the flow rate through part or all of the system is less than 500 L/min. In one embodiment, the flow rate through part or all of the system is less than 1000 L/min. In one embodiment, the flow rate through part or all of the system is less than 2000 L/min.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Example 1: Approaching Infinite Selectivity in Membrane Based Aqueous Lithium Extraction Via Solid-State Ion Transport

Conventional strategies to extract lithium from aqueous sources rely on pre-concentration via solar evaporation, followed by a series of chemical-based purification and precipitation steps. Meanwhile ion-exchange resins and adsorbents have been highly investigated for lithium extraction, though such methods still require partial pre-concentration of lithium due to their limited lithium selectivity over competing cations and necessitate large volumes of freshwater or chemicals to regenerate. In contrast, electrochemical lithium intercalation, in which lithium ions are capacitively stored in layered or lattice structures, most commonly seen in battery electrodes, has demonstrated impressive lithium selectivity over both magnesium and sodium. Nonetheless, intercalation-based approaches currently suffer from severely limited electrode lifespan and require periodic regeneration, inherently requiring semi-batch operation (P. K. Choubey, et al., Miner Eng 89, 119-137 (2016); A. Khalil, et al., Desalination 528, 115611 (2022); M. L. Vera, et al., Nat Rev Earth Env 4, 149-165 (2023); C. Liu et al., Joule 4, 1459-1469 (2020); Z. Y. Guo, et al., Desalination 533, 115767, (2022); R. Trócoli, et al., Chem-Eur J 20, 9888-9891 (2014); L. Wu et al., Water Res 221, 118822, (2022); E. J. M. Dugamin, et al., Sci. Rep. 11, 21091 (2021); H. Fan, et al., J. Memb. Sci. 573, 668-681 (2019)).

Highly selective membranes, that facilitate the preferential transport of lithium over competing species, have the potential to overcome the limitations of ion-exchange and intercalation-based approaches by providing continuous and sustainable lithium recovery. Considerable research efforts towards the development of lithium-selective membranes have culminated in materials which are capable of strongly distinguishing between lithiFum and magnesium, primarily by exploiting differences in ion valency, hydrated size, and hydration energy. However, the effective separation of monovalent ions, such as lithium and sodium, has proven significantly more challenging, with little to no selectivity being realized in the majority of synthetic membranes and nanochannels. As typical brines contain substantially higher concentrations of sodium compared to lithium, the practical effectiveness of direct lithium extraction using current state-of-the art membranes is limited. Thus, the continued investigation of membrane materials which provide high lithium selectivity against both commonly competing divalent and monovalent ions remains critical (Q. Peng et al., Nature Communications 15, 2505 (2024); A. Razmjou, et al., Nature Communications 10, 5793, (2019); Y. Guo, et al., Angew Chem Int Edit 55, 15120-15124 (2016); J. Lu et al., Nat Mater 19, 767-774 (2020); H. C. Zhang et al., Sci Adv 4, eaaq0066, (2018); R. J. Mo et al., Nature Communications 15, 2145, (2024); L. X. Hou et al., Adv Funct Mater 31, 2009970 (2021); C. Y. Zhang, et al., J Membrane Sci, 596, 117724, (2020); N. T. Eden et al., ACS Applied Engineering Materials 1, 2336-2346 (2023);

Motivated by safety concerns stemming from the flammability of commonly used liquid electrolytes, the batteries field has increasingly focused on the development of solid-state electrolytes (SSE)-rigid three-dimensional cation-anion frameworks which allow for the migration of a mobile cation. In these solid materials, the transport of a mobile cation is facilitated through the migration of defects (i.e., vacancy or interstitial sites) in the crystalline structure. Though solid-state electrolytes have become a highly investigated research area in the battery community, culminating in the development of highly conductive materials, limited attention has been given towards their potential application as a unique class of membrane materials for aqueous ion separations. While a few proof-of-concept studies have demonstrated that SSE materials could be used for selective extraction of lithium ions from seawater, fundamental evaluation and understanding of transport in SSEs applied to aqueous systems remains unexplored (T. Famprikis, et al., Nat Mater 18, 1278-1291 (2019); J. C. Bachman et al., Chem Rev 116, 140-162 (2016); B. K. Zhang et al., Energy Storage Mater 10, 139-159 (2018); S. X. Yang, et al., Joule, 2, 1648-1651 (2018); T. Hoshino, Desalination, 359, 59-63 (2015); Z. Li et al., Energ Environ Sci, 14, 3152-3159 (2021)).

A lithium ion conducting SSE was assessed as a membrane for aqueous lithium extraction. The fundamentals of ion and water transport in the SSE were investigated while providing direct comparison to a conventional cation-exchange membrane to highlight the unique mechanisms of solid-state diffusion. The ion-ion selectivity of the SSE against commonly competing cations in lithium brines was evaluated. The results reveal immeasurably low fluxes for competing salt ions over all investigated conditions, indicating virtually perfect lithium selectivity. Using molecular dynamics simulations in conjunction with experimental characterization techniques, mechanistic insights into the atypical ion-ion selectivity phenomena observed with the SSE were uncovered. Practical implications of the observed SSE performance were considered and critical research directions for the continued development of these SSE were discussed.

### Results and Discussion

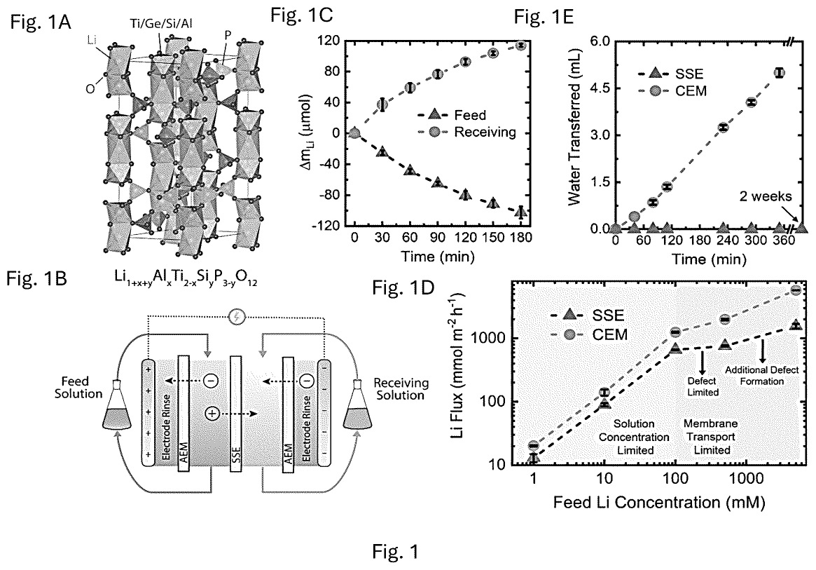

Though SSEs have been extensively studied in solid-state batteries, such materials have yet to be thoroughly assessed as membrane materials for aqueous separations. Hence, the transport of water and lithium ions between two aqueous solutions separated by an SSE was explored. Throughout this study, a commercially available lithium ion conducting NASICON type SSE was used (FIG. 1A). Specifically, the rhombohedral crystal lattice is a doped variant of LiTi₂(PO₄)₃, in which a portion of the titanium atoms have been substituted for germanium, aluminum, or silicon to enhance the ionic conductivity. Nonetheless, the typical NASICON type crystal structure is maintained, whereby phosphate tetrahedra share corners with metal octahedra including titanium, germanium, aluminum, or silicon, and mobile lithium ions occupy either octahedral lattice sites or less energetically favorable tetrahedral interstitial sites during ion migration. Notably, this particular NASICON type SSE was selected due to its high lithium ion conductivity and exceptional water stability, in contrast to most other SSE material classes which readily decompose in the presence of water (K. Momma and F. Izumi, J Appl Crystallogr, 44, 1272-1276 (2011); B. Akkinepally, et al., Ceram Int, 48, 12142-12151, (2022); F. Bai et al., Front Energy Res, 8, 187 (2020)).

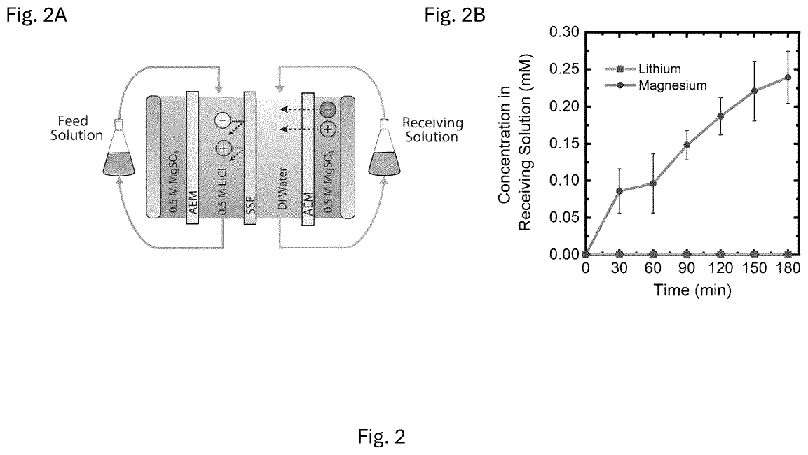

It is well established in the literature that transport across the crystalline framework of an SSE occurs via hopping of the mobile cations across point defects, either in the form of lattice site vacancies or through the insertion of ions into interstitial sites. In battery systems, the required energy to induce such defects is provided via an electric field driving force. However, membrane processes may also utilize various other driving forces for mass transport, such as a pressure or concentration gradient. Thus, the permeability for lithium ions via pure diffusion was investigated. However, throughout such diffusion experiments no lithium flux was detected across the SSE, even in the presence of a 500 mM lithium ion transmembrane concentration difference (FIG. 2). It is important to note that in the absence of an electric field, the condition of charge neutrality in each solution requires that lithium ions diffuse across the SSE alongside an anion such as chloride ions. Hence, the lack of concentration gradient driven lithium transport arises from the exclusion of anions by the SSE. Specifically, while the SSE structure accommodates the migration of lithium ions, the insertion of chloride ions or other anions into the crystalline structure is expected to be highly unfavorable due to their larger ionic size and opposite valency. Accordingly, the SSE materials are not likely to be practical in concentration gradient-or pressure-driven applications, where the flux of cations and anions is coupled. Additionally, inorganic SSE materials are unsuitable for pressure-driven applications, as they are generally mechanically inflexible and brittle. Thus, for the remainder of this study, ion transport across the SSE solely under an applied electric field was assessed.

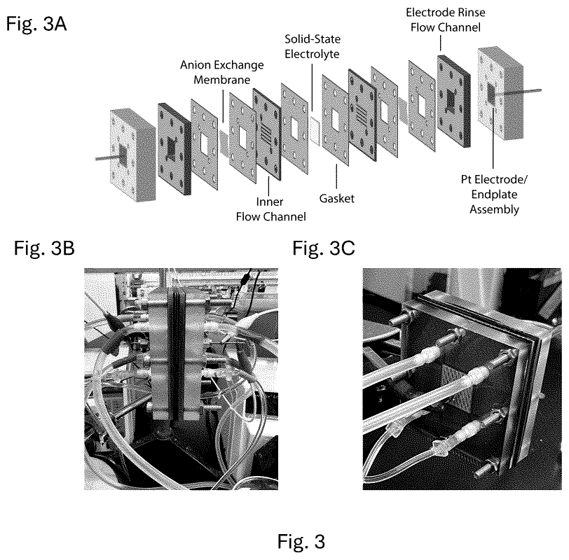

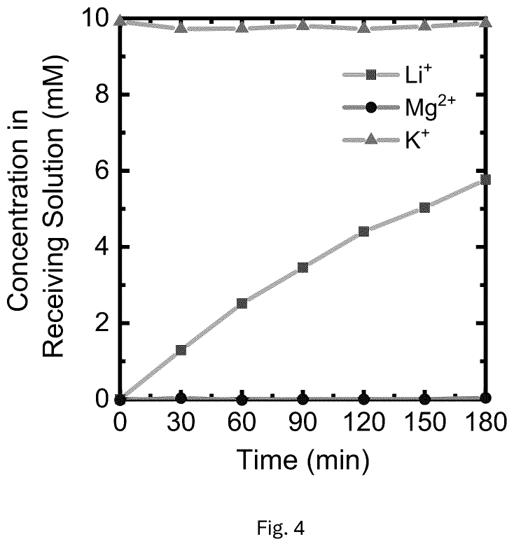

Upon incorporating the SSE into an electrodialysis cell (FIG. 1B and FIG. 3). Applying a constant cell potential of 4 V, the concentration of lithium ions in the receiving compartment was found to continuously increase over time, while the concentration of other cations in the receiving solution, such as K⁺, Mg²⁺, and H⁺, remained relatively invariable (FIG. 4). Thus, it was determined that lithium is the primary cationic charge carrier. However, with the SSE framework inherently consisting of lithium ions, it is necessary to ensure that the observed lithium in the receiving solution is not a result of leaching from the material.

To identify the source of the accumulating lithium ions in the receiving solution, a mass balance across the feed and receiving solutions was performed. As shown in FIG. 1C, over the three-hour duration of applying a potential, the lithium concentration in the feed solution decreased, while the lithium concentration in the receiving solution increased. This mirroring of concentration change across the feed and receiving solutions assures that lithium ions are not being depleted from the SSE material, but are rather migrating through it from the feed solution to the receiving solution. While the magnitudes of the concentration change in the feed and receiving solutions align closely, the amount of lithium in the receiving solution is consistently ˜12 μmol greater than the feed solution. Notably, this difference is found to emerge within the first 20 minutes of applying a potential, after which the change in concentration between the solutions is found to be nearly equal and opposite. The initial divergence is attributed to start-up phenomena, such as the release of surface adsorbed lithium ions on the SSE.

To gain further insight into ion transport through the SSE, the effect of external solution concentration of lithium ions was investigated. While the composition of the feed solution remained solely lithium chloride (LiCl) throughout, the concentration of LiCl was varied over orders of magnitude from 1 mM to 5000 mM LiCl. To contextualize the magnitude of the lithium flux in the SSE, the same set of experiments were performed with a conventional cation exchange membrane (CEM). As shown in FIG. 1D, the lithium flux for both the SSE (blue points and purple line) and CEM (green points and orange line) show a clear dependence on the external solution concentration, generally increasing with the feed solution concentration. Notably, over the entire concentration range assessed, the lithium flux for the SSE remained below that of the CEM, albeit to varying extents depending on the solution concentration. As the membrane was the only variable that was changed across these experiments, the SSE poses a higher transport resistance compared to the CEM. Further discussion provided in the following section.

For both the SSE and CEM, the dependence of the lithium flux on external solution concentration can be broken into two distinct regimes. Specifically, as the concentration is increased from 1 mM LiCl up to 100 mM LiCl, the lithium flux for both membrane types follows nearly the same power relation, indicating that similar phenomena are likely limiting the attainable flux. At lithium chloride concentrations >100 mM, however, this relationship no longer holds, and the lithium fluxes for the CEM and SSE begin to diverge more significantly.

Hence, the similar power law relation observed for both the SSE and the CEM in the lower concentration regime is expected to be related to the effects of the low electrolyte concentration. Specifically, at such low salt concentrations, the solution resistance and diffusion boundary layer resistances at the membrane-solution interface are likely to be dominant over the membrane resistance. Therefore, in this regime, the lithium flux is highly sensitive to the feed solution concentration, whereby increasing the solution concentration by an order of magnitude also correlates to nearly an order of magnitude enhancement of lithium flux (P. Dlugolecki et al., J Membrane Sci, 349, 369-379 (2010); P. Dlugolecki, et al., J. Memb. Sci. 319, 214-222 (2008); J. Kamcev et al., J Membrane Sci, 547, 123-133, (2018)).

In contrast, at concentrations >100 mM LiCl, the solution resistance and diffusion boundary layer resistance are effectively minimized, leading to decreased sensitivity of the lithium flux to solution concentration. Hence, in this regime, the lithium flux is expected to be membrane transport limited, making differences between the transport mechanisms of the SSE and CEM more apparent. Specifically, the lithium flux through the CEM follows a relatively consistent relation with solution concentration, while in the case of the SSE the lithium flux demonstrates two distinct growth rates (an initial plateau followed by a continued increase in flux) as the solution concentration is progressively increased.

The observed solution concentration dependence of the CEM and SSE may be understood by considering the properties which dictate its ionic conductivity. With ion-exchange membranes, increasing the external solution concentration leads to gradual screening of the membrane's fixed charge and thus weakened Donnan exclusion. Consequently, more co-ions are introduced into the membrane matrix, which, due to charge neutrality, must be accompanied by an increased number of counterions (i.e., lithium ions). This increased total ion concentration in the membrane effectively leads to higher ionic conductivity at the expense of greater salt leakage (i.e., decreased permselectivity). Notably, these effects are consistently magnified as the solution concentration is increased, in agreement with the observed rate of growth in the lithium flux.

As with an ion-exchange membrane, the conductivity of an SSE is directly related to the number of mobile charge carriers within the material. However, the number of lithium ions which may be accommodated in an SSE remains primarily fixed by the crystalline structure and the condition of charge neutrality. Thus, in a crystalline SSE, the number of mobile charge carriers-rather than being the number of lithium ions-is more accurately interpreted as the number of point defects (i.e., cationic vacancies and interstitials). With the formation of these point defects being a thermally activated process, increasing the chemical potential energy of the system, such as by increasing the feed solution concentration, may induce the formation of a larger number of defects, thus opening up additional ion migration pathways and increasing the SSE conductivity. However, a notable increase in the growth rate of the flux is only observed when an extreme LiCl concentration of 5000 mM is utilized, implying that within practical solution concentration ranges, the number of available defects, and hence the conductivity, in the SSE remains relatively fixed, thus limits the attainable lithium flux. It should also be noted that while the SSE conductivity may be increased through inducing a larger amount of point defects, excessive defect formation could lead to destabilization of the lattice structure and eventual degradation of the SSE.

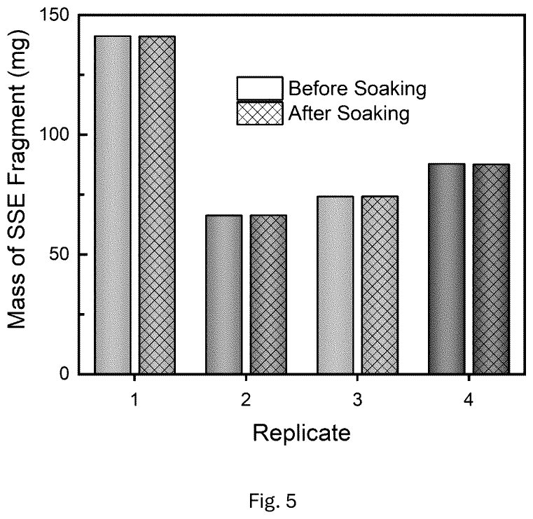

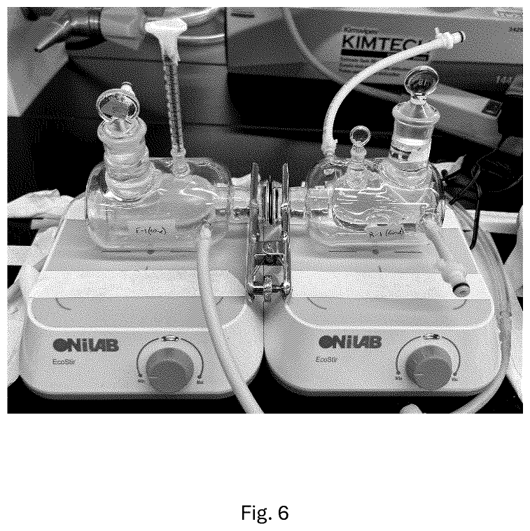

While the SSE is confirmed to serve as a conductor for lithium ions, aqueous separations also inherently involve water molecules, which may interact with or traverse the SSE. To evaluate the interaction of the SSE with water molecules, water uptake experiments were conducted in which the mass of several SSE fragments was compared before and after long term exposure to water. Overall, no change in the mass was observed, indicating that the material does not readily absorb water or decompose in the presence of water (FIG. 5). Furthermore, the permeability of water through the SSE material was evaluated by completing a series of osmosis experiments, in which the SSE separated a concentrated (500 mM) sucrose solution from deionized water (FIG. 6). Though the large osmotic pressure difference (˜12 bar) between the two solutions provides a substantial driving force for water to traverse the membrane, no change in the volume was observed over the course of two weeks (FIG. 1E). In contrast, when the SSE was replaced with a CEM, a steady water flux was observed within just one hour.

The impermeability of the SSE to water is likely due to water molecules not being able to penetrate the rigid and tightly packed NASICON crystalline lattice (FIG. 1A). Specifically, analysis of the crystalline lattice of LiTi₂(PO₄)₃, a close analogue of the SSE utilized in this study (i.e., without doping), reveals that the distance between many oxygen atoms is less than the diameter of a water molecule, which is 2.7 Å, thus preventing access into the structure. The inability of water molecules to enter the crystalline lattice was further confirmed by executing PoreBlazer simulations on the LiTi₂(PO₄)₃ unit cell using a 2.7 Å sized probe. The calculations determined that although the interstitial space in LiTi₂(PO₄)₃ has a total volume of 286.2 Å³, none of the free volume is accessible to the probe, thus supporting the experimental findings that water molecules are unable to enter the SSE structure. Importantly, this conclusion implies that ion transport in the SSE occurs solely under anhydrous conditions, in which ions are fully stripped of their hydration shell (L. Sarkisov, et al., Chem Mater, 32, 9849-9867 (2020)).

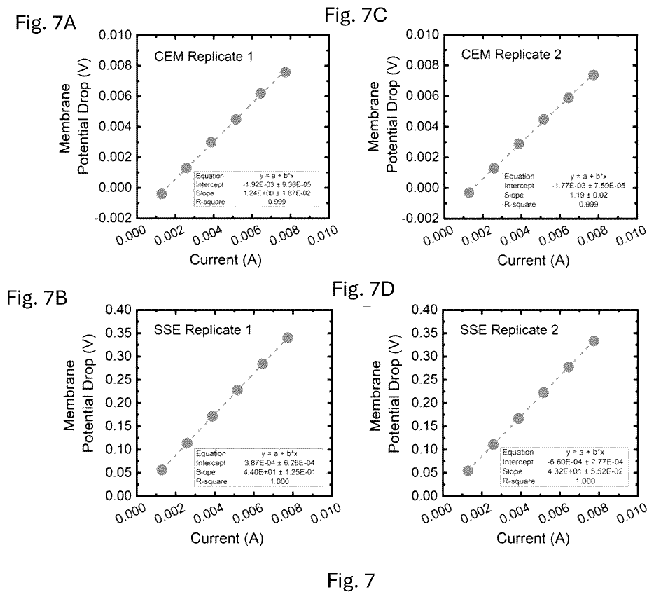

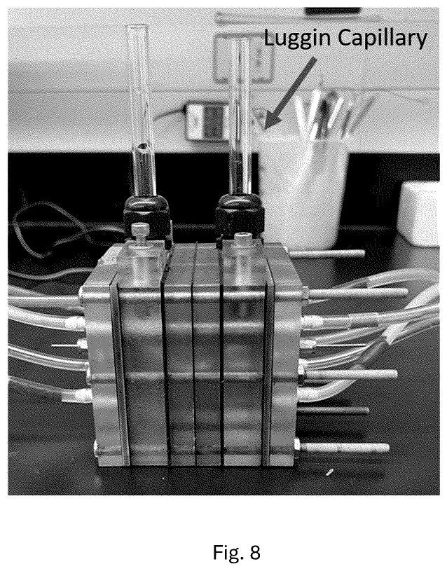

While in the flux of lithium ions across the SSE was determined over various conditions, the fundamental intrinsic membrane properties-which facilitate more meaningful and direct comparison between materials-were not assessed. The ionic conductivity of the SSE and CEM was quantified to gauge the relative case with which a lithium ion may traverse each type of material (FIG. 7). A custom-built electrodialysis flow-cell utilized to measure the conductivity and energy barriers of the SSE and CEM is shown in FIG. 8. To ensure the measured conductivity was primarily reflective of transport across the membrane, and did not include significant contributions from external resistances, for example from solution resistance and diffusion boundary layers, a high salt concentration (500 mM LiCl) solution was utilized and vigorous mixing of the solution in each compartment was provided. Nonetheless, the conductivity of the SSE was found to be 0.05 mS cm⁻¹, approximately one-half of the reported conductivity by the manufacturer. Such discrepancy may be attributed to the measurement of the SSE conductivity in an aqueous system, as opposed to the typical method of testing SSE conductivity in a solid-state battery cell. Specifically, in an aqueous system, it is likely that the ion dehydration required for lithium to partition from solution into the SSE imposes a larger overall transport resistance compared to the deintercalation of already dehydrated lithium ions in battery electrodes, thus leading to a lower practically measured conductivity.

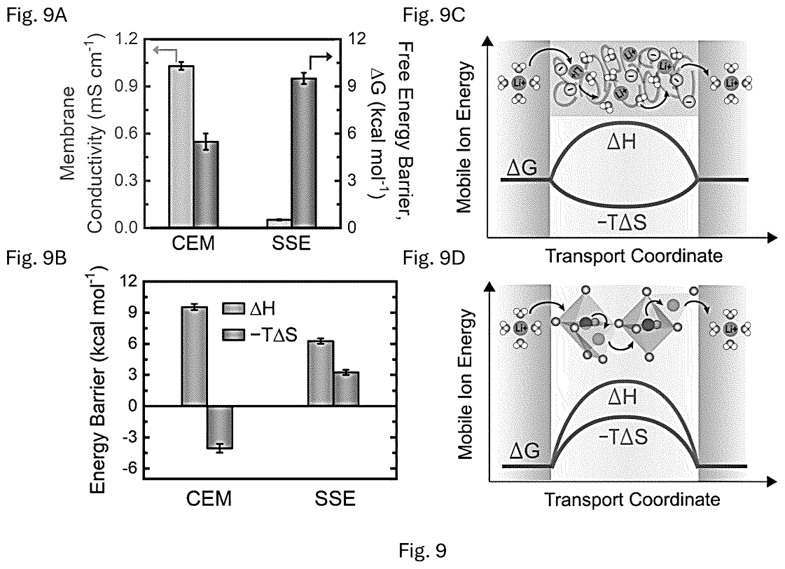

In comparison to the SSE, the CEM was found to have a substantially higher ionic conductivity (FIG. 9A). Specifically, the lithium conductivity of the CEM was measured to be nearly 20 times greater than that of the SSE, emphasizing the distinct modes of transport in each type of membrane. The higher conductivity of the CEM may be rationalized by considering that ions are considerably more mobile in large (nanometer-scale) water-filled channels as compared to highly confined crystalline solids. Whereas the tight and rigid packing of atoms in the SSE structure does not allow for the penetration of water molecules—and thus only facilitates ion transport through classical solid-state diffusion mechanisms—ion-exchange membranes are composed of flexible polymer chains that swell under aqueous conditions, effectively forming interconnected water channels through which ions migrate. Hence, unlike the SSE, ion transport in the CEM may be interpreted as tortuous (i.e., between randomly oriented polymer chains) and hindered transport (i.e., due to interactions with fixed charge groups) through a liquid phase (H. Mehrer, Diffusion in solids: fundamentals, methods, materials, diffusion-controlled processes. (Springer Science & Business Media, 2007), vol. 155; J. Kamcev, et al., Macromolecules, 51, 5519-5529, (2018); H. Yasuda, et al., Makromol Chem, 118, 19-35 (1968)).

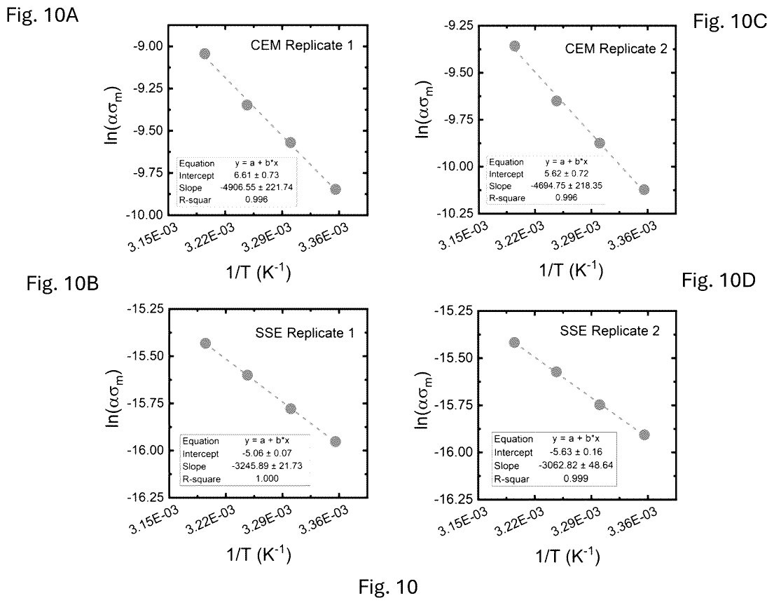

Though the conductivity is a useful intrinsic property for comparing membrane performance, it is insufficient for describing the molecular level interactions between the mobile ion and the membrane, which ultimately dictate transport. Transition state theory, in contrast, provides greater fundamental insight by assuming that the transport of an ion through a membrane can be perceived as hopping among equilibrium states at various energy levels. Each of these attempted hops is thus associated with an energy barrier which may originate from various molecular-level phenomena such as ion dehydration, steric hindrance, or interaction of ions with moieties in the membrane structure. Hence, to elucidate the fundamental differences between transport in the SSE and CEM, the energy barrier of lithium ion permeation for each membrane was determined (FIG. 9A and FIG. 10) (I. Shefer, et al., Environ Sci Technol, 56, 7467-7483, (2022); B. J. Zwolinski, et al., J Phys Colloid Chem, 53, 1426-1453, (1949); C. L. Ritt et al., Sci Adv, 8, eabl5771 (2022)).

The overall energy barrier for lithium transport through the SSE was found to be higher than that of the CEM by 3.7 kcal mol-1, in good agreement with the measured conductivity at room temperature (FIG. 9A). Nonetheless, to draw further insight into the mechanistic differences in transport through the SSE and CEM, the respective enthalpic and entropic contributions were compared. As the enthalpic barrier reflects the specific interactions between the ion and the membrane during ion partitioning and transmembrane transport, it is often associated with phenomena such as ion dehydration, electrostatic interactions, and ion-ligand binding within the membrane. Hence, it could intuitively be expected that the SSE should have a larger enthalpic penalty compared to the CEM because partitioning of lithium ions into the SSE requires complete dehydration. Nonetheless, the activation enthalpy for the SSE was 3.3 kcal mol-1 smaller than that of the CEM (FIG. 9B). To understand such a result, it is critical to note that shedding of the hydration shell is accompanied by simultaneous interactions with moieties of the membrane, which can effectively stabilize the ion and offset the energetic penalty of ion dehydration (X. C. Zhou et al., Sci Adv, 6, (48): eabd9045 (2020)).

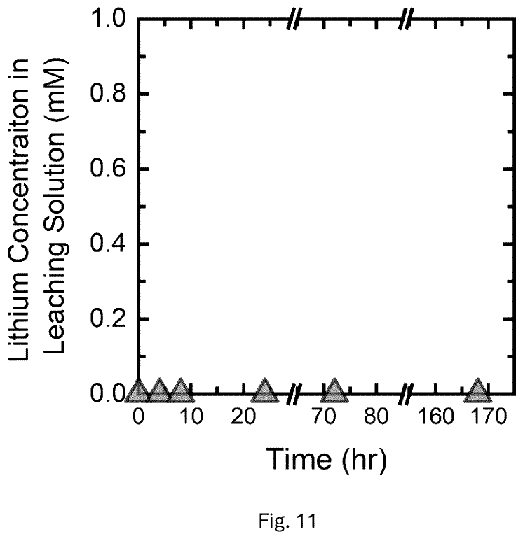

In aqueous solution, lithium ions are stabilized via ion-dipole interactions with the electronegative oxygen atoms of water molecules, typically forming a tetrahedral configuration with four water molecules. Notably, in the NASICON-like SSE used in this study, lithium ions are similarly stabilized through coordination with either four tetrahedral interstitial sites or six octahedral lattice site oxygen atoms (FIG. 9D). To assess which coordination environment is more favorable for the lithium ion within the SSE framework or the hydration shell in solution, leaching experiments with the SSE were performed (FIG. 11). While the dissolution of lithium ions from the SSE is entropically favorable, no lithium ions were found to leach into solution over several days. Therefore, it can be implied that the SSE framework provides superior stabilization of the lithium ion (i.e., enthalpic favorability) compared to the hydration shell in solution (P. E. Mason, et al., J Phys Chem B 119 (5), 2003-2009 (2015); H. H. Loeffler and B. M. Rode, J Chem Phys 117, 110-117 (2002); S. Varma and S. B. Rempe, Biophys Chem 124, 192-199 (2006); B. Lang, et al., Chem Mater 27, 5040-5048 (2015)).

The suspected offset of the dehydration energy penalty is further validated by the magnitude of the measured enthalpic barrier closely agreeing with the activation energy values commonly reported for similar NASICON-like structures in the solid-state battery literature. Accordingly, the enthalpic barrier of the SSE-both in aqueous and solid-state applications-primarily reflects the energy penalty incurred for defect formation and migration. Specifically, partitioning of an ion into the SSE framework simultaneously requires the formation of either a vacancy or interstitial defect through energetically unfavorable bond breakage or formation, effectively contributing to the overall enthalpic energy barrier. Additionally, subsequent migration of the lithium ion through the crystalline framework further adds to the enthalpic barrier, as lithium ions cross from highly stabilized lattice sites through relatively less stable interstitial sites.

Similarly, the relatively large enthalpic barrier of the CEM may be interpreted through consideration of the ion interactions with the negative fixed charge groups of the membrane (i.e., sulfonate groups on the polymer backbone). While the negative fixed charge groups in the CEM provide favorable electrostatic interactions with lithium ions for partitioning, once inside the CEM such interactions effectively hinder transport and must be overcome for the ion to traverse the membrane. Furthermore, it is important to note that in comparison to the closely packed and highly ordered structure of the SSE, the negative fixed charge groups in the CEM are widely spaced (on the order of 10 Å) and randomly dispersed. Thus, during both the ion partitioning and transmembrane diffusion steps, the lithium ion is expected to pass through higher energy transition states in the CEM as compared to in the SSE, in which oxygen atoms are ideally arranged for the stabilization of dehydrating and migrating lithium ions (J. C. Díaz et al., Macromolecules 57, 2468-2481 (2024); H. Q. Fan et al., Acs Est Eng, 2 (7), 1274-1286 (2022)). While migrating through either the SSE or CEM ultimately incurs an enthalpic penalty, the entropic changes in each membrane type provide alternate contributions to the total free energy barrier. Specifically, ion transport in the SSE is found to result in an overall decrease in entropy compared to bulk solution, whereas the entropy change in the CEM is found to be positive and have negative—TΔS, in agreement with entropy barriers reported for cation transport in CEMs. Accordingly, transport in the CEM is found to be entropically favorable, effectively compensating for the corresponding high enthalpic barrier. In contrast, transitioning from bulk solution to the lower entropy states in the SSE requires energetic input, thus adding to the enthalpic barrier.

Transport of an ion through a membrane inherently confines the mobility of the ion compared to bulk solution, thus decreasing entropy. However, the nanometer scale pores in ion-exchange membranes are large and facilitate relatively unhindered freedom of molecular motion compared to other membrane types. Interactions with the polymer chains and fixed charge groups, nonetheless, are likely to lead to disruption of the hydration shell around the lithium ions (FIG. 9C). Such temporary breakage and rearrangement of the structurally ordered hydration shell in the activated state would effectively increase the entropy of the lithium ion, which is expected to culminate in a net gain in entropy during ion migration through the CEM. In contrast to a CEM, the freedom of motion of lithium ions is severely more restricted in an SSE, with the ions only being able to occupy and migrate through the lattice (octahedral) and interstitial (tetrahedral) sites of the highly ordered and rigid crystalline network (FIG. 9D). The distinct mechanisms of transport are illustrated for each membrane type in FIG. 9C and FIG. 9D. In the CEM, the ions interact with the negative fixed charge groups in the membrane while traversing tortuous hydrated free volume elements between polymer chains. In the SSE, the lithium ions undergo dehydration as they partition into the SSE, while simultaneously being stabilized by the oxygen atoms in the lattice. The dehydrated lithium ions undergo single-file hopping through octahedral and tetrahedral sites as they migrate across the crystalline structure. The relative entropic and enthalpic barriers for transport are shown for the mechanisms of transport in the CEM and SSE. Furthermore, transport through the SSE requires migration through size-restrictive bottlenecks as the lithium ions hop from lattice to interstitial sites. For NASICON-like SSE materials, in particular, the size of these migration bottlenecks is only a few angstroms; thus, traversing such channels necessitates single-file ion transport and poses substantial steric hindrance effects. Such confined and ordered transport increases entropy relative to that of the hydrated lithium ion in bulk solution, as supported by the substantial entropic barrier measured for the SSE (N. Kononenko et al., Adv Colloid Interfac 246, 196-216 (2017); R. Y. Wang and S. H. Lin, Environ Sci Technol 58, 3552-3563 (2024); A. Martinez-Juarez, C. Pecharroman, J. E. Iglesias and J. M. Rojo,. J Phys Chem B 102, 372-375 (1998); L. Zhu et al., Sci Adv 8, eabj7698, (2022); Z. Y. Zou et al., Adv Funct Mater 31, (49): 2107747 (2021)).

The assessment of the SSE thus far has focused on understanding the mechanisms of lithium ion and water transport in the material, while highlighting how such phenomena fundamentally differ from that in more conventional nanoporous membranes. Hence, until now, only single salt solutions consisting of lithium chloride were utilized. However, in practical aqueous membrane applications, such as lithium extraction, it is necessary to separate lithium ions from a complex mixture containing relatively high concentrations of co-existing ions. Specifically, most relevant source waters contain substantial concentrations of sodium and magnesium ions, making lithium extraction with membranes highly challenging. Accordingly, the selectivity of the SSE for lithium transport against both sodium and magnesium was investigated.

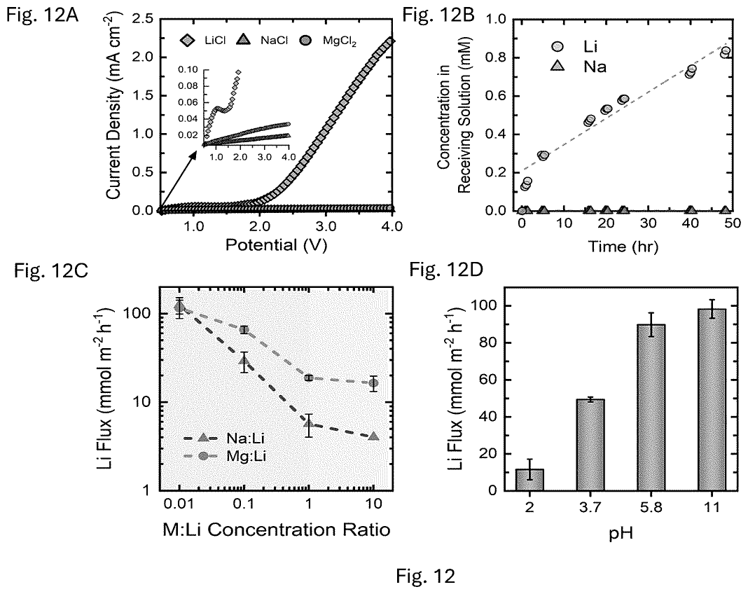

To begin the assessment of selectivity, single-salt experiments with 100 mM solution of either lithium chloride, sodium chloride, or magnesium chloride were performed. As the applied potential was linearly increased, the current response, which is reflective of the transmembrane ion flux, was monitored (FIG. 12A). With the lithium chloride solution, the current remained near zero and rapidly encountered a plateau region until reaching a potential of ˜1.5 V, at which an inflection point was observed. Notably, ˜1.5 V is the practical water splitting potential, suggesting that at lower applied potentials, the lithium flux across the SSE is limited by the occurrence of electrochemical reactions at the electrodes. Nonetheless, beyond 1.5 V, the current rapidly grew, indicating that higher applied potential leads to greater flux of lithium ions across the SSE, as would be expected.

Upon replacing the lithium chloride solution with sodium chloride or magnesium chloride, however, the profile of the current response entirely changed and the magnitude of the current drastically dropped. Specifically, for both the sodium and magnesium solutions, the current showed a relatively linear increase over the entire applied potential window (FIG. 12A, inset graph), with no sign of an onset potential as was observed with the lithium chloride solution. Such a result suggests that with both the sodium chloride and magnesium chloride solutions, there is a lack of viable charge carriers across the SSE, and that the marginal current observed can likely be attributed to unavoidable leakage current in the electrochemical cell, rather than transmembrane ion flux. Notably, towards higher applied potentials, where the current response for the lithium chloride solution is significant, the current diverged from that of sodium and magnesium chloride solutions by nearly two orders of magnitude, alluding to potentially high lithium selectivity.

While the single-salt experiments provide an initial indication of promising ion-ion selectivity in the SSE, competitive ion-membrane interactions can lead to significant variation in multi-salt solutions. Hence, evaluation of lithium selectivity continued through a long-term electrodialysis experiment in which a solution consisting of equimolar lithium and sodium (10 mM each) was continuously fed to the cell. Over the duration of the two-day constant voltage experiment, the flux of lithium remained fairly constant after the first hour, leading to a linear increase in the lithium concentration in the receiving solution over time (FIG. 12B). Accordingly, the SSE was found to possess a high degree of stability under electrodialytic operation and in the presence of moderate concentrations of sodium. Remarkably, throughout the entirety of the long-term experiment there was no detectable sodium flux, as confirmed by both ion-chromatography and ICP-MS. Hence, the SSE is found to provide near perfect selectivity for lithium transport over sodium (R. M. DuChanois et al., Sci Adv 8, eabm9436 (2022)).

To further investigate the selectivity of the SSE and uncover potential limitations, performance with various feed solution mixtures and concentrations was systematically tested. Mixed salt experiments in which 10 mM LiCl was combined with varying concentrations of either sodium or magnesium chloride were performed, effectively covering a wide range of molar ratios between the competing cation and lithium ion. A concentration of 10 mM LiCl was used throughout the competitive ion transport tests to reflect the minimum lithium ion concentration required in practical feedwaters for economically viable extraction. Notably, across all the solution combinations investigated, no sodium or magnesium flux was detected (by either ion-chromatography or ICP-MS), resulting in ideal selectivity for lithium transport. Nonetheless, while the selectivity was maintained across all solution conditions investigated, a critical tradeoff relationship between the lithium flux and the competing ion concentration was revealed (FIG. 12C). Particularly, at low competing ion concentration, a M: Li molar ratio of 0.01, the lithium flux for both the sodium and magnesium mixed salt solutions remained comparable to that observed with pure 10 mM LiCl solution. However, as the molar ratio of the competing cation was progressively increased to 0.1 and 1.0, substantial decline in the lithium flux was observed, indicating that the competing ions, despite not crossing the SSE, pose considerable hindrance for lithium permeation. Such an effect may suggest that competing cations inhibit the partitioning of lithium ions into the SSE via surface site blocking, with further discussion of this hypothesized mechanism provided in the following section. Notably, as the competing ion concentration ratio was further increased from 1.0 to 10.0, the relative decline in the lithium flux for both sodium and magnesium containing solutions began to plateau, implying that the surface sites on the SSE began to saturate with the competing ion.

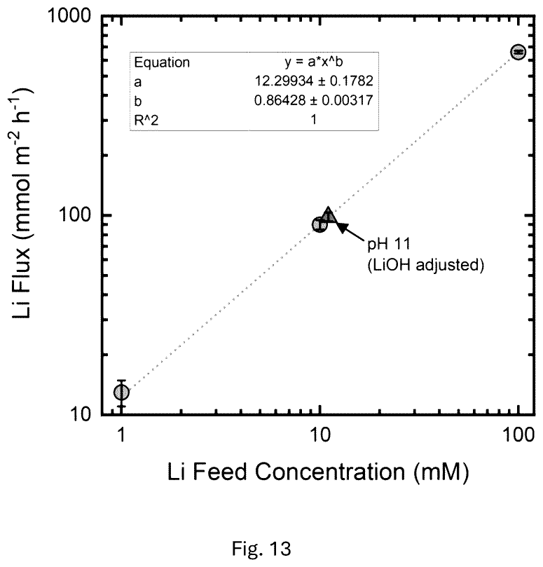

The potential interference from protons in solution was also investigated by determining the lithium flux through the SSE with feed solutions at various pH (FIG. 12D). At circumneutral and high pH conditions, in which the proton concentration is negligible, the lithium flux was found to remain relatively unchanged. Though a slight increase in lithium flux was observed at pH 11, this is attributed to the increased lithium concentration in the feed solution, a consequence of raising the pH through dosing of lithium hydroxide, as depicted in FIG. 13. It should be noted that while a high pH provides a substantial concentration of hydroxide ions, which are small and highly mobile compared to the lithium ion, under an applied electric field, the hydroxide ions migrate away from the SSE, effectively minimizing impact on the flux of lithium. In contrast, with lower pH feed solutions, the flux of lithium was found to be severely reduced, implying that protons, like other cations, pose competitive effects with lithium. Notably, the results show that even at a H⁺: Li⁺ ratio of 0.01, at a pH 4, the lithium flux drops by nearly half, while at the same competing ion ratio, sodium and magnesium ions had no impact on the lithium flux. Thus, lithium transport across the SSE is found to be more sensitive to the presence of protons as compared to salt ions.

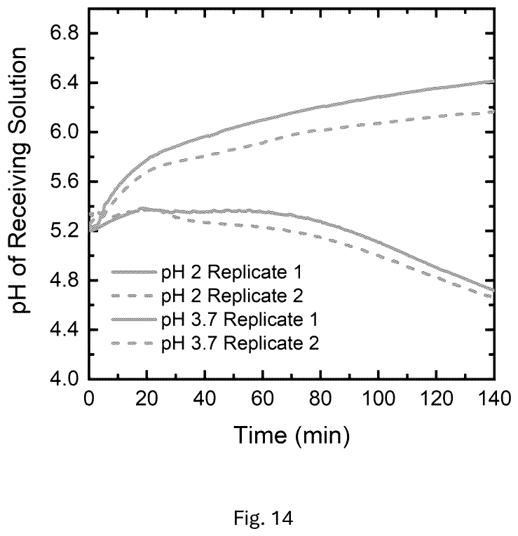

To determine whether protons traverse the SSE, the pH of the receiving solution was monitored over the duration of the pH 2 and pH 3.7 experiments. As seen in FIG. 14, the experiments conducted at pH 3.7 unintuitively showed an increase in the pH of the receiving solution, rather than a decrease in pH which would indicate transmembrane proton transport. However, this result may be understood by considering that the electrochemical reduction reactions at the cathode, including a hydrogen evolution reaction, generate hydroxide ions, which can readily migrate across the anion exchange membrane (AEM) that separates the electrode rinse solution from the receiving solution (FIG. 1B). In effect, the pH change from potential proton migration across the SSE is likely to be masked in the case of the pH 3.7 experiments. Nonetheless, for the experiments conducted at pH 2, a decline in the receiving solution pH was observed over time, indicating a clear flux of protons through the SSE that outweighed the corresponding flux of hydroxide ions through the AEM. Importantly, such a result demonstrates that the reduction in lithium flux at low pH values is likely due to the competitive migration of protons throughout the SSE, unlike in the case of salt ions which also reduce the lithium flux, but without permeating the membrane.

Through the assessment of the SSE, unprecedented selectivity for lithium transport over both sodium and magnesium was demonstrated. Furthermore, a unique relationship was uncovered, whereby the lithium flux was found to decline with increasing concentration of co-existing sodium and magnesium ions, though no transmembrane flux of the competing ions was observed. While such performance is highly promising in the context of ion separations, the observed phenomena are not common of other ion-selective membrane processes. Hence, in this section, molecular simulations with experimental characterizations are used to elucidate the unique underlying mechanisms governing competitive ion transport in the SSE.

To gain insight into the interactions between the ions and SSE, molecular dynamics simulations were performed on three systems which closely resembled the previous experimental conditions. Specifically, an electric field was applied across an SSE separating two aqueous salt solutions. The receiving solution remained potassium chloride, while the feed solution was systematically varied to contain either pure lithium chloride, equimolar lithium and sodium chloride, or equimolar lithium and magnesium chloride. Though the commercial SSE material used in this study is doped, including having a portion of the titanium atoms are substituted with germanium, silicon, and aluminum to enhance ionic conductivity, for the general purpose of understanding competitive ion effects the SSE was simulated using the simplified crystal structure of unsubstituted, yet structurally similar LiTi₂(PO₄)₃.

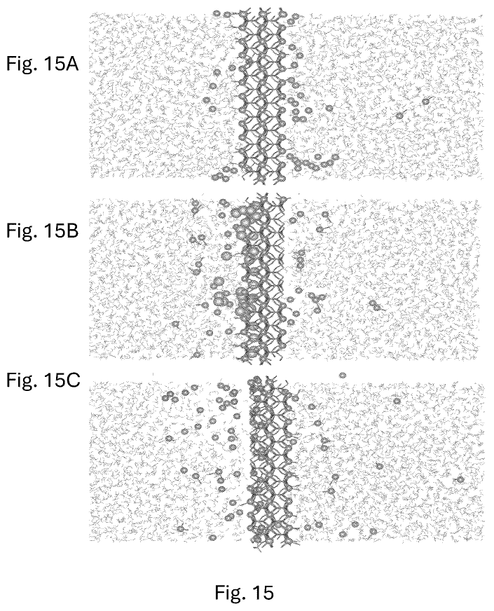

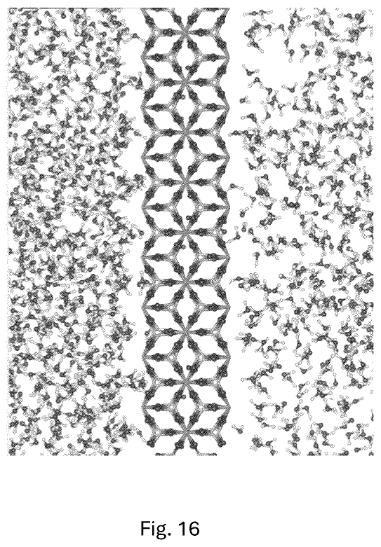

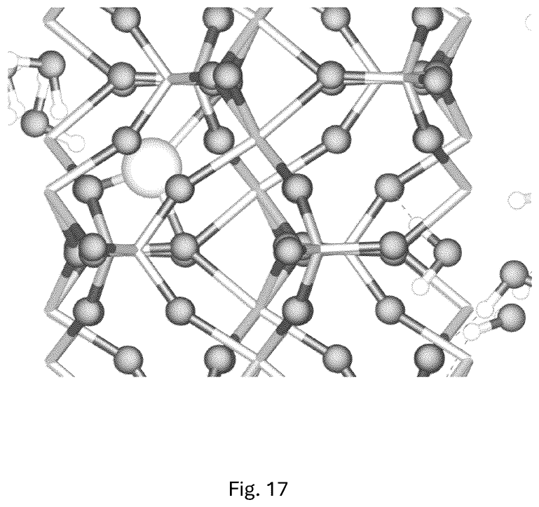

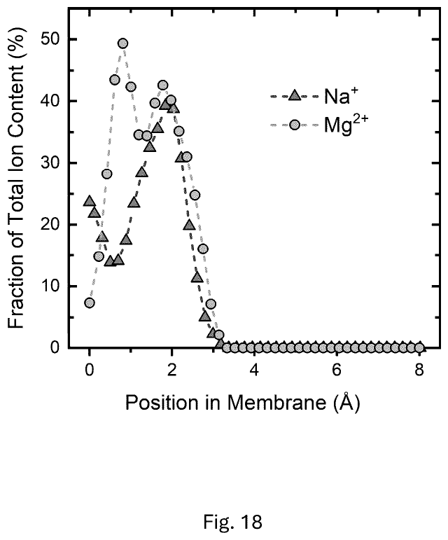

As shown by the simulation snapshots for each system (FIG. 15), lithium was found to traverse the SSE under all conditions. Furthermore, the molecular dynamics simulations reinforce the water transport experiments, showing that water molecules are unable to penetrate the SSE structure (FIG. 16), and, thus, lithium ions migrate across the SSE in an anhydrous state (FIG. 17). Sodium and magnesium, however, were unable to cross the SSE structure, in agreement with previous experimental results. Notably, the simulations showed a buildup of sodium and magnesium ions at the surface of the SSE, with neither ion being capable of penetrating past ˜3 Å of the SSE's top atomic layer. The magnesium ions, nonetheless, are found to distribute more evenly within this surface region as compared to sodium ions, which is likely attributed to their smaller ionic size (FIG. 18).

The impermeability of the sodium ion through the SSE may be attributed to its relatively large ionic size compared to lithium ions. As previously discussed, transport in the SSE occurs under anhydrous conditions through a crystalline lattice; thus, the bare ionic radii must be considered. Specifically, for coordination numbers ranging from four to six as would typically be encountered in the structure of the SSE, the lithium ionic diameter ranges from 1.18 to 1.52 Å, whereas sodium ranges from 1.98 to 2.04 Å. While such sub-angstrom ionic size differences cannot readily be differentiated in conventional nanoporous membranes, the lithium conducting NASICON materials have been shown to possess angstrom scale conducting channels. Thus, such materials could effectively provide size sieving of the larger sodium ions while facilitating the passage of the relatively small lithium ions (R. D. Shannon, Acta Crystallogr A 32, 751-767 (1976); E. R. Nightingale, J Phys Chem-Us 63, 1381-1387 (1959); Y. Marcus, J Chem Soc Faraday T 87, 2995-2999 (1991)).

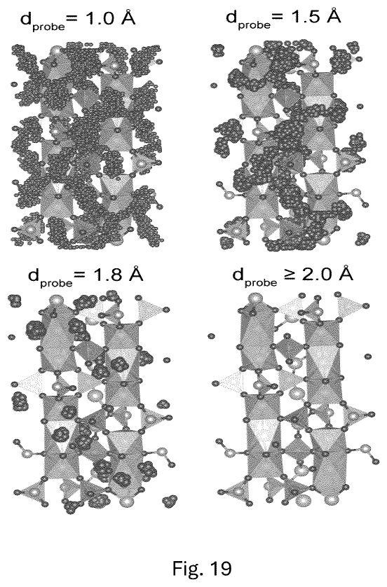

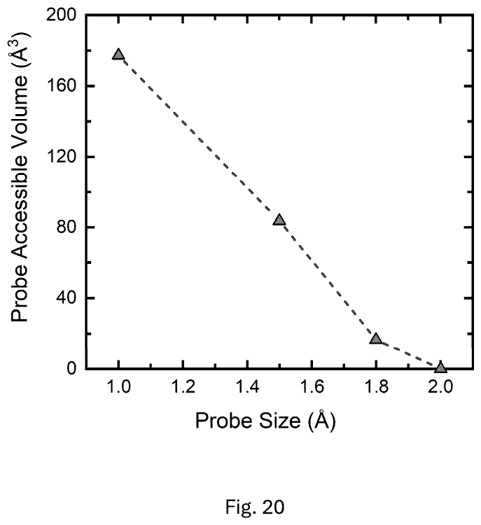

To further validate and visualize this size exclusion mechanism, additional simulations were performed using PoreBlazer. As shown in FIG. 19, variously sized spherical probes were administered to effectively map out the size of the interstitial sites within the SSE structure. When a probe size of 1.0 Å was applied, the majority of the interstitial volume was accessible, as indicated by the pervasiveness of the pink spheres. However, as the probe size was gradually increased, the accessibility of the probe to the interstitial spaces was significantly reduced (FIG. 20). Notably, with a probe size of 1.5 Å, which may be considered representative of the size of a lithium ion, the probe accessible fractional free volume shrinks from 62% to 29%. Nonetheless, as can be seen in FIG. 19, the interstitial spaces between the lattice sites of lithium shown as the green octahedrons, remain occupiable, allowing for lithium ions to still pass from one lattice site to another. When the probe size is increased to 1.8 Å, however, this interconnectedness of lattice sites is broken, and further increasing the probe size to 2.0 Å—the size of a sodium ion—leads to complete loss of accessibility to the free volume elements. Hence, the effective bottleneck size for ion migration determined by the simulations was between 1.8 Å and 2.0 Å, in good agreement with values previously reported through more standard geometric calculations. Accordingly, sodium ions, when provided enough energy, may exchange for lithium ions in the lattice sites; however, further penetration into the SSE framework is likely prevented by their inaccessibility into the size restrictive interstitial sites.

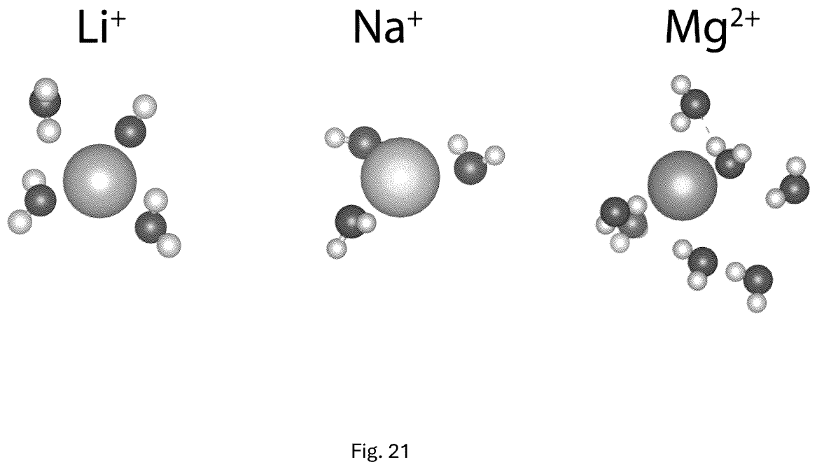

While sodium ions are excluded from the SSE due to a size sieving mechanism, magnesium ions, which effectively are the same diameter as lithium ions (Table 1), are also found to be impermeable. Such a result implies that ion selectivity in the SSE is not only dependent on the ionic size but is also related to the charge of the ion. Specifically, the divalent nature of magnesium ion is expected to substantially alter its interaction with the SSE framework, which is composed of mobile monovalent lithium ions. Whereas monovalent ions, like sodium, may exchange for the lithium ions in the SSE structure, while still maintaining overall charge neutrality in the framework, the introduction of a magnesium ion into the framework would inherently require the formation of an additional vacancy defect. Thus, the enthalpic energy barrier for divalent ion migration through the SSE is expected to be considerably larger than that of monovalent ions, as supported by recent density functional theory calculations (M. H. Zhang et al., Energ Fuel 37, 10663-10672 (2023)). Furthermore, the divalent nature and small ionic size of magnesium lead to a larger and more tightly held hydration shell, relative to monovalent sodium and lithium ions (Table 1 and FIG. 21).

TABLE 1
The properties of the ions relevant to the competitive ion transport
experiments. The crystallographic diameter (i.e., ion size in a
crystalline lattice) is provided for tetrahedral (IV) and octahedral
(VI) coordination environments. The hydrated diameter and hydration
energy of the ions is also provided for aqueous environments.

| | Crystallographic | Hydrated | Hydration |
|---|---|---|---|
| | Diameter Coordination | Diameter | Energy |
| Ion | IV/VI (Å)(57) | (Å)(74) | (kJ mol⁻¹)(75) |
| Li⁺ | 1.18/1.52 | 7.64 | −475 |
| Na⁺ | 1.98/2.00 | 7.16 | −365 |
| Mg²⁺ | 1.14/1.32 | 8.56 | −1830 |

Considering both the large hydration energy of magnesium ions and the incompatibility of divalent ions (in place of lithium ions) in the SSE structure, partitioning of magnesium ions into the SSE is likely to incur a large energetic penalty (i.e., the energy barrier of magnesium ion dehydration is not offset by stabilization within the SSE framework).

In addition to the exceptional ion selectivity, the competitive ion transport experiments also revealed an unexpected relationship between the lithium flux and the competing ion concentration. Particularly, though zero flux of sodium or magnesium was observed, the lithium flux was severely reduced in their presence. Notably, the molecular dynamics simulations show a similar trend, whereby the lithium flux was reduced when sodium and magnesium ions were introduced to the system, albeit to a smaller extent. As suggested by the simulations shown in FIG. 15, this flux reduction effect is likely attributed to the accumulation of the impermeable sodium and magnesium ions near the SSE surface. Specifically, while the competing ions do not cross the SSE, their surface level ion-exchange into the SSE effectively blocks lithium ions from accessing otherwise viable lattice and interstitial sites for partitioning. Both the experimental (FIG. 12C) and simulation (FIG. 15) results showed a more drastic reduction in the lithium flux when the interfering ion was sodium as opposed to magnesium. Hence, it may be inferred that, compared to sodium ions, magnesium ions interact less with the SSE structure, or are more readily reversibly exchanged with lithium ions from the feed solution.

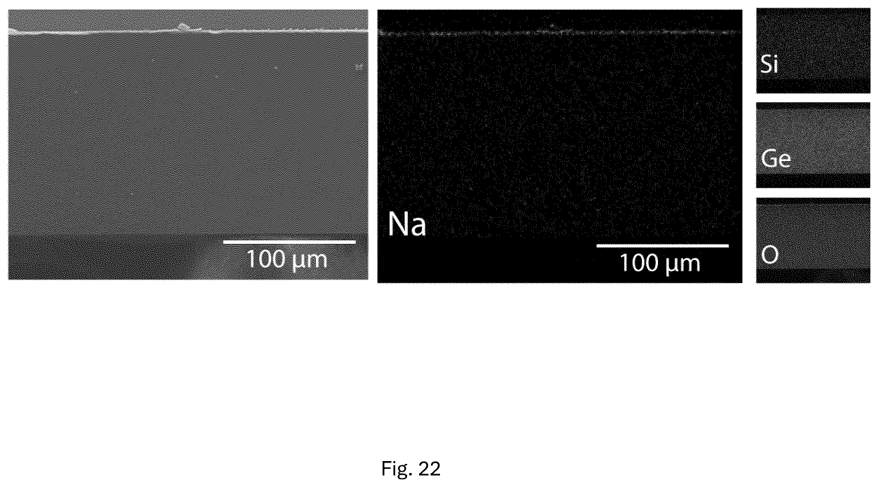

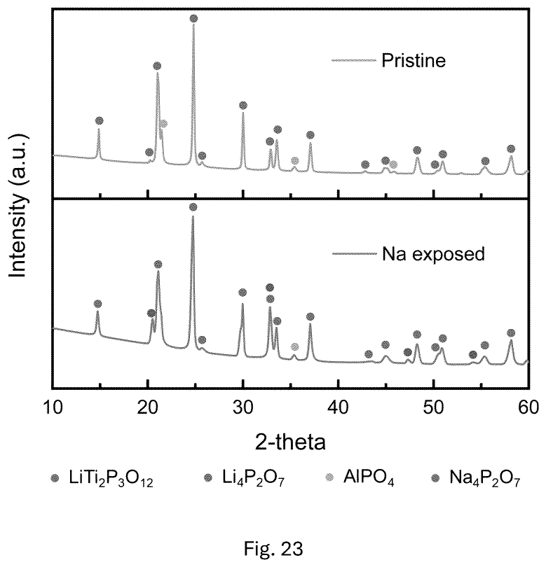

To further support the theory of interfacial ion-exchange blocking the flux of lithium, scanning electron microscopy-energy dispersive spectrometry (SEM-EDS) mapping was performed on the cross-section of the SSE after a long-term experiment where the feed solution consisted of equimolar lithium and sodium (FIG. 22). The elemental mapping of the cross-section clearly shows homogenous distribution of oxygen, silica, and germanium across the entire membrane thickness, as would be expected from the chemical structure of the SSE. Notably, however, sodium was also detected, though it was found to only be present at the feed-side surface of the material. As the surface of the SSE had been thoroughly rinsed with deionized water to remove surface adsorbed species prior to imaging, this result provides strong evidence that sodium integrates into the structure of the SSE, but is unable to migrate past the surface layer, thereby hindering the transport of lithium ions. Furthermore, x-ray diffraction was performed on the SSE both before and after the long-term mixed salt experiment. As shown in FIG. 23, the diffraction pattern of the SSE showed notable deviation from the pristine after the electrodialysis test, indicating alteration of the crystalline structure. Upon further analysis of the phases, the changes in the diffraction pattern reflect transformation of Li₄P₂O₇ to Na₄P₂O₇, supporting that sodium exchanges for lithium at the solution-SSE interface.

In a first exemplary process, an electrodialysis stack consists of alternating anion-exchange membranes and solid-state electrolytes between a single pair of electrodes (FIG. 26). Numerous cell pairs including AEM, SSE, and flow channels, may be incorporated into a single electrodialysis stack. A lithium containing feed solution, from which lithium is to be extracted, is fed to alternating channels in the electrodialysis stack. A dilute lithium solution free of other impurities is fed to the other flow channels and serves as the recovery solution. A dilute lithium salt solution is utilized, as opposed to deionized water to ensure electrical conductivity of the solution, which is required for optimal electrodialysis operation. Such a dilute lithium solution may be made up from using a small amount of the final generated lithium product. Under the applied electric field, lithium ions are transported across the solid-state electrolyte to the recovery solution, while other cations are retained in the original feed solution. The recovery solution is recirculated at a fixed recycle ratio to concentrate the lithium to a level where it may be precipitated upon addition of sodium carbonate or sodium hydroxide, for example as lithium carbonate or lithium hydroxide, respectively. The precipitation of the lithium salt is induced in a crystallizer, which is external to the recovery solution recirculation loop as to avoid introducing sodium ions into the recirculating recovery solution. The effluent from the crystallizer, which is likely to still contain an appreciable concentration of lithium but is contaminated with sodium due to the crystallization process, is fed back and mixed with the feed solution to increase the overall lithium recovery of the process. Similarly, the lithium depleted effluent from the electrodialysis stack for example from the channels that were supplied the “lithium containing feed solution” is partially mixed with the feed solution to maximize the overall process-scale lithium recovery. Due to the extreme selectivity of the solid-state electrolyte, a high purity lithium hydroxide or lithium carbonate product is produced.

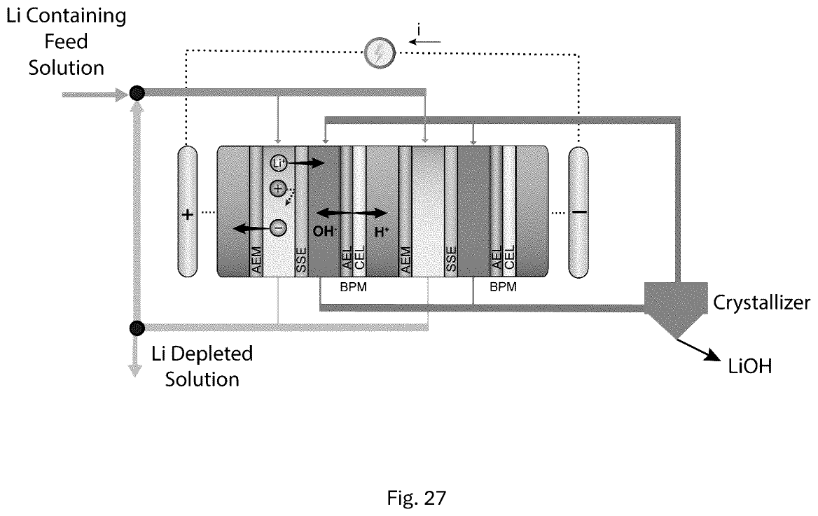

In a second exemplary process, a bipolar membrane electrodialysis stack consists of multiple cell pairs, each consisting of an anion-exchange membrane, solid-state electrolyte, and bipolar membrane (FIG. 27). A lithium containing feed solution, from which lithium is to be extracted, is fed into the channels between the anion-exchange membrane and solid-state electrolyte. Under the applied electric field, lithium ions are transported across the solid-state electrolyte to the adjacent channel, while other cations are retained in the original feed solution. This feed solution is recirculated at a fixed recycle ratio to maximize the process-scale lithium recovery. In the adjacent flow channels, for example between the solid-state electrolyte and bipolar membrane, hydroxide ions are generated by the dissociation of water molecules. Thus, in these channels lithium and hydroxide ions are combined. Due to the extreme selectivity of the solid-state electrolyte, high purity lithium hydroxide is produced in these channels. Recirculation of the lithium hydroxide solution leads to concentration of the ions until crystallization is induced in an in-line crystallizer unit. Notably, no external chemical addition is required to obtain the final lithium hydroxide product. The process also produces an acidic stream (red flow channels) due to the water dissociation. The acidic flow channels are expected to be highly concentrated with protons and chloride ions, as chloride is the major anion of most naturally occurring lithium brine solutions. Thus, the acidic streams may be leveraged for potential production of hydrochloric acid (with additional downstream purification).

In a third exemplary process, a bipolar membrane electrodialysis stack consists of multiple cell pairs, each consisting of an anion-exchange membrane, solid-state electrolyte, and bipolar membrane (FIG. 28). A lithium containing feed solution, from which lithium is to be extracted, is fed into the channels between the anion-exchange membrane and solid-state electrolyte. Under the applied electric field, lithium ions are transported across the solid-state electrolyte, to the adjacent channel, while other cations are retained in the original feed solution. This feed solution is recirculated at a fixed recycle ratio to maximize the process-scale lithium recovery. In the adjacent flow channels, for example between the solid-state electrolyte and bipolar membrane, hydroxide ions are generated by the dissociation of water molecules. Thus, in these channels lithium and hydroxide ions are combined. Hydroxide solutions (i.e., high pH) can serve as sorbents for carbon dioxide CO₂ capture. Thus, the lithium hydroxide that is produced in this recirculation loop is exposed to either atmospheric conditions through direct air capture or a more concentrated point source of CO₂. As CO₂ is dissolved into the high pH solution, chemical equilibrium shifts towards the formation of carbonate ions, which combine with the lithium ions to form a pure lithium carbonate (Li₂CO₃) product in the in-line crystallizer unit. Notably, no external chemical addition is required to obtain the final lithium carbonate product, and CO₂ capture is simultaneously achieved. The process also produces an acidic stream due to the water dissociation. The acidic flow channels are expected to be highly concentrated with protons and chloride ions, as chloride is the major anion of most naturally occurring lithium brine solutions. Thus, the acidic streams may be leveraged for potential production of hydrochloric acid (with additional downstream purification).

### Advantageous Effects

Over recent decades, solid-state electrolyte materials have attracted considerable research attention, being primarily guided by application in battery technologies. In this study, SSEs were demonstrated be highly promising as ion-selective membranes for aqueous separations. By systematically comparing a state-of-the-art NASICON-like lithium ion conductor to a cation-exchange membrane, it was demonstrated how water and lithium transport fundamentally vary in an SSE as compared to conventional polymeric membranes. Unlike other classes of membrane materials, ion transport in SSE frameworks occurred under anhydrous conditions via solid-state diffusion mechanisms, ultimately limiting the attainable ion flux. Nonetheless, while the lithium ion permeability of the SSE was determined to be lower than that of traditional membranes—due largely in part to the relatively high entropic barrier for transport—the highly ordered structure and angstrom-scale migration pathways provide unparalleled selectivity for the transport of lithium over both sodium and magnesium ions.

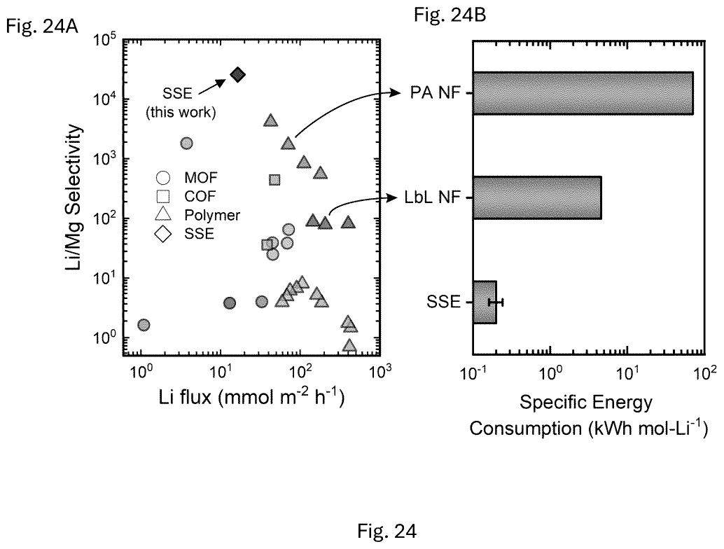

Though the lithium flux through the SSE is severely reduced in the presence of competing cations, the flux values still remain comparable to those observed in considerably less selective membrane materials, such as polyelectrolyte multilayer films, metal-organic frameworks, and covalent organic frameworks. To highlight the relative performance of the SSE, the lithium-magnesium selectivity as a function of the lithium flux for several membranes reported in the literature was determined (FIG. 24A). Data is summarized in Table 2 (R. M. DuChanois et al., Environ Sci Technol 57, 6331-6341 (2023); N. Ul Afsar et al., Desalination 458, 25-33 (2019); T. T. Xu et al., Chemsuschem 12, 2593-2597 (2019); H. Xiao et al., J Membrane Sci 670, 121312 (2023); M. Mohammad, et al., Appl Mater Today 21, 100884 (2020); F. M. Sheng et al., Adv Mater 33(44):e2104404 (2021); L. X. Hou et al., Adv Funct Mater 31, 2009970 (2021); N. T. Eden et al., ACS Applied Engineering Materials 1, 2336-2346 (2023); C. Y. Zhang, et al., J Membrane Sci 596, 117724 (2020); Y. Guo, et al., Angew Chem Int Edit 55, 15120-15124 (2016); Q. Peng et al., Nature Communications 15, 2505 (2024); L. Wang et al., Acs Appl Mater Inter 13, 16906-16915 (2021); R. He et al., Desalination 525 (38): 115492 (2022).

TABLE 2
Lithium flux and lithium-magnesium selectivity for various
membrane materials reported in the literature

| Membrane Type | Li flux (mmol m⁻² h⁻¹) | Li/Mg Selectivity Factor |
|---|---|---|
| COF(6) | 38.3 | 36 |
| COF(7) | 47.5 | 443 |
| MOF(8) | 1.08 | 1.63 |
| MOF(9) | 32.76 | 4 |
| MOF(10) | 45 | 25 |
| MOF(10) | 44.64 | 39 |
| MOF(10) | 68.4 | 38.5 |
| MOF(10) | 71.28 | 65 |
| MOF(11)^{,}* | 3.73 | 1815 |
| MOF(12) | 12.96 | 3.8 |
| Polymer(13) | 42.37 | 4147 |
| Polymer(13)^{,#} | 70.32 | 1705 |
| Polymer(13) | 110.88 | 828 |
| Polymer(13) | 178.49 | 548 |
| Polymer(14) | 74.02 | 6.1 |
| Polymer(14) | 58.97 | 3.9 |
| Polymer(14) | 105.30 | 8 |
| Polymer(14) | 89.66 | 6.7 |
| Polymer(14) | 67.51 | 4.9 |
| Polymer(15)^{,#} | 204.96 | 78.5 |
| Polymer(15) | 143.66 | 87.2 |
| Polymer(15) | 399 | 81.1 |
| Polymer(16) | 428.4 | 1.46 |
| Polymer(16) | 185.04 | 3.83 |
| Polymer(16) | 160.92 | 5.16 |
| Polymer(16) | 396 | 1.74 |
| Polymer(16) | 414 | 0.7 |
| SSE (this work) | 16.4 | 25704 |

*The lithium flux was calculated based off the provided current density data in 0.5M LiCl solution.
^{#}The specific energy consumption for this data point is shown in FIG. 5B.

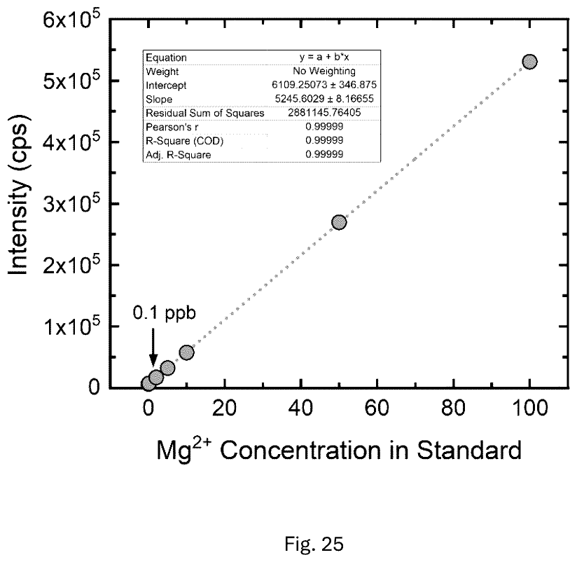

In order to compare the results of this study to the literature, a lithium-magnesium selectivity value was approximated using the limit of detection of the ICP-MS (FIG. 25). However, it is important to note that no magnesium flux was detected in the previous experiments, and thus the reported selectivity is a minimum value based on the experimental measurement capabilities. While FIG. 24A shows that most materials, including the SSE, abide by a general permeability-selectivity tradeoff relationship, the orders-of-magnitude gain in selectivity offered by the SSE comes at a relatively small expense in flux. Furthermore, we note that the reported lithium flux of the SSE is not optimized and can potentially be increased by varying the operating conditions (e.g., stronger applied electric field or higher fluid velocity to reduce concentration polarization effects) or by developing thinner membranes.

It is also important to note that in FIG. 24A, only the lithium-magnesium separation performance was considered due to the relative abundance of such data in the literature. However, in practical source waters, the concentration of lithium ions is generally dwarfed by that of co-existing sodium ions. While solubility differences between sodium and lithium precipitates, for example Na₂CO₃ and Li₂CO₃, may be exploited to achieve downstream chemical separation, the presence of high sodium concentrations can compromise final lithium product purity and can adversely impact the efficiency of the DLE process. In electro-driven membrane processes, in particular, the energy consumption directly scales with the current or number of ions transported. Thus, high lithium-sodium selectivity is critical to minimize the amount of current wasted towards the transport of sodium ions. Nonetheless, reported materials which show high lithium-magnesium selectivity typically lack sufficient selectivity between lithium and sodium ions, limiting their practical viability (P. K. Choubey, et al., Miner Eng 110, 104-121 (2017); K. Ooi et al., Hydrometallurgy 174, 123-130 (2017); T. Tran, and V. T. Luong, Lithium Process Chemistry, A. Chagnes, J. Światowska, Eds. (Elsevier, Amsterdam, 2015), pp. 81-124; Y. Zhang, et al., Miner Eng 139, 105868 (2019)).

Similarly, reports on lithium-selective membranes commonly overlook the importance of lithium-water selectivity. Specifically, though pressure-driven nanofiltration membranes have demonstrated high lithium-magnesium selectivity with relatively high lithium flux, it is critical to realize that the majority of energy input in such systems is expended towards the transport of water molecules, rather than lithium ions. Hence, the specific energy consumption (SEC) for pressure-driven lithium extraction, using even the most promising NF membranes reported in the literature, remains orders of magnitude higher than that of the SSE (FIG. 24B). Notably, the SEC of lithium extraction using the SSE may be even further reduced by scaling up of the demonstrated system to a multi-cell pair electrodialysis stack, in which the contribution of the redox potential of the electrodes becomes negligible (S. K. Patel, et al., Environ Sci Technol 54, 3663-3677 (2020)).

The extension of SSE materials into aqueous ion separations presents both new research challenges and opportunities. Only one NASICON-like SSE was utilized as a model material; however, systematic evaluation of various classes of SSE materials for example LISICON, garnet, and perovskite may enable further understanding of the underlying mechanisms and potential of solid-state ion conductors in the context of ion-ion selectivity. Nonetheless, such investigations would require the development of more water-stable SSE materials, which are now relatively scarce. Additionally, applying the SSE to an aqueous system, rather than a solid-state battery inherently alters the interfacial phenomena. Though substantial research focus has been directed towards the understanding and optimization of the SSE-electrode interface in solid-state batteries, the SSE-solution interface in electrodialysis introduces unique considerations. Future study of the SSE-solution interface is also particularly critical for developing strategies to mitigate the blockage of the SSE surface sites by competing ions, thus allowing for a high lithium flux to be maintained in the presence of coexisting cations.

With supply shortages rapidly approaching, the need to harness lithium from increasingly complex aqueous ionic mixtures continues to grow. Based on the exceptional lithium ion selectivity demonstrated, SSE materials will be at the forefront of direct lithium extraction technologies. However, the potential application of SSE membranes is not limited to lithium alone. Though focus on battery technologies has culminated in an assortment of lithium and sodium ion conductors, the extreme selectivity demonstrated by solid-state transport mechanisms is expected to inspire the development of alternate ion-conductors for the efficient extraction of other critical elements from aqueous sources.

### Materials and Methods

Materials and Chemicals: Lithium chloride (J.T. Baker, >99.5%), sodium chloride (Sigma Aldrich, >99%), potassium chloride (Sigma Aldrich, >99%), magnesium chloride hexahydrate (Sigma Aldrich, >99%), and ammonium chloride (J.T. Baker, >99.5%) were dissolved in MilliQ ultrapure deionized water (>18 M (2 cm) for the preparation of various salt solutions. A commercially available NASICON type solid-state-electrolyte (Ohara LICGC AG-01) was used throughout the study, and replaced after each experimental set or as needed (i.e., drop in ionic conductivity or visible cracking of the material was observed). Notably, this particular SSE was selected due to its high lithium ion conductivity and exceptional water stability, as reported by the manufacturer. A commercial cation-exchange membrane (Fumasep FKD-PK-75) and anion-exchange membrane (Fumasep FAS-PET-130) were utilized. A CH Instruments 600E potentiosat was used to perform all electrochemical techniques throughout the study.

Determination of Ion Flux and Selectivity: The ion flux across the SSE and the CEM were determined by operating a custom built electrodialysis (ED) cell (FIG. 1A and FIG. 3), with details on the cell design provided in the Supplementary Materials. The ED system was operated in batch mode, in which 20 mL of the feed solution, which varied in composition depending on the experiment, and 20 mL of the receiving solution (10 mM KCl) were continuously recirculated at a flow rate of 1 mL min⁻¹ through the corresponding channels in the cell (FIG. 1B). For experiments in which the pH of the feed solution was varied, lithium hydroxide or hydrochloric acid were utilized to increase or decrease the pH, respectively. Potassium chloride was utilized in the receiving solution, as opposed to deionized water, to provide solution conductivity. A 10 mM solution of Na₂SO₄ was used as the electrode rinse solution, except when sodium was present in the feed solution, in which case the electrode rinse solution was substituted with 10 mM MgSO₄ to avoid any potential error in the cation flux measurement stemming from co-ion leakage across the anion-exchange membranes. The electrode rinse solution (150 mL) was continuously recirculated at a flowrate of 8 mL min⁻¹, and the rinse solutions from both the anode and cathode were mixed into the same batch, ensuring minimal pH variation of the bulk electrode rinse solution over the duration of the batch.

Before beginning the experiment, the ion-exchange membranes were soaked in the corresponding solution overnight for equilibration. Upon assembling the system, DI water was pumped through each of the chambers in a single-pass operation mode for 20 minutes to remove any adsorbed ions on the surface of the membranes. The effluent was disposed after a single pass through the cell. Air was then pumped through the channels to empty the chambers of any residual water, after which the experimental solutions were recirculated through their corresponding channels for 30 mins to bring the system to an equilibrium.

A constant potential of 4 V was applied over a duration of two hours, and the current response was recorded in 1 s intervals. The feed and receiving solutions were sampled every twenty minutes, and sodium, lithium, and magnesium concentrations were measured using a Metrohm 940 Professional IC Vario ion chromatograph as well as a PerkinElmer Nexion 5000 multi-quadrupole ICP-MS. The flux of each species (Jᵢ) was calculated according to:

$${J}_{i} = \frac{Δ {C}_{i} V}{{A}_{m} Δ t} \qquad ( 1 )$$

where ΔCᵢ is the change in the concentration of the species in the receiving solution, V is the volume of the recirculating receiving solution, Aₘ is the exposed membrane area (3.2 cm²), and Δt is the time duration over which the concentration change is measured. The ion flux measurements were determined according to the concentration data collected from 60 mins onwards, a period over which the flux/current had reached a steady state value. All experiments which measured membrane flux were carried out in triplicate.

A long-term experiment with the SSE was conducted for fifty hours, over which a constant potential of 4 V was applied. A feed solution consisting of 10 mM LiCl and 10 mM NaCl was continuously fed to the feed chamber at a rate of 1 mL min⁻¹ in single pass operation and the effluent was disposed. A 20 mL solution of 10 mM KCl was recirculated through the receiving chamber over the entire duration of the experiment and 0.1 mL samples were taken from this vessel. The electrode rinse solution (2 L of 10 mM MgSO₄) was recirculated at a rate of 8 mL min⁻¹. After the long-term experiment, the SSE was removed from the cell, thoroughly rinsed with ultrapure deionized water and characterized.

The selectivity for lithium transport over other cations (S_{Li/i}) is determined for multi-salt feed solutions according to:

$${S}_{Li / i} = \frac{Δ {C}_{L i} {C}_{f , i}}{Δ {C}_{i} {C}_{f , Li}} \qquad ( 2 )$$

where ΔC_{Li} is the change in the lithium concentration in the receiving solution over the duration of the batch, while C_{f,Li} and C_{f,i} are the feed concentrations of lithium and the competing species, respectively.

Linear sweep voltammetry experiments were conducted using a single salt solution such as 100 mM NaCl, LiCl, or MgCl₂, which was fed to both the feed and receiving channels. The solution was recirculated into the same reservoir, ensuring minimal variation in concentration over the duration of the experiment. The electrode rinse solution was 10 mM Na₂SO₄ or MgSO₄, depending on the feed solution used. The voltage was swept at a rate of 2 mV s⁻¹ from 0 V to a final potential of 4 V.

Measurement of Membrane Conductivity and Energy Barriers: Measurements of the membrane conductivity and energy barriers were obtained using a modified version of the electrodialysis cell, where the central serpentine flow channels were replaced with 1.5″ thick (3.81 cm) open flow channels (FIG. 8). Luggin capillaries were inserted into the flow channels and filled with 1 M KCl, and an Ag/AgCl reference electrode (Pine Research LowProfile) was immersed in the solution of each capillary. The Luggin capillary tips were in close proximity to the central membrane, which was the membrane under investigation, and the potential difference across the tips was measured via the reference electrodes using a digital multimeter.

The same solution of 0.5 M LiCl (250 mL) was recirculated through each of the inner flow channels; hence, despite lithium transporting across the central membrane, such as from the feed to the receiving chamber, under an applied current the overall lithium concentration in the feed solution remained constant over the duration of the experiment. This effectively minimized temporal variation in the measured potential difference. The flowrate through the central chambers was set to 20 mL min⁻¹ and stirring was provided in each channel with a magnetic stir bar to ensure sufficient mixing and minimization of boundary layer effects. A 500 mL solution of 10 mM Na₂SO₄ was recirculated through both of the electrode rinse channels at a flow rate of 15 mL min⁻¹.

The conductivity of the central membrane was determined by measuring the potential difference across the membrane (Adm) at various applied current densities (i.e., 0.2, 0.4, 0.6, 0.8, 1, 1.2 mA cm⁻²). The slope of the measured membrane potential drop versus the applied current density gives the resistance (Rₘ) of the membrane (FIG. 7). The membrane conductivity (σₘ) can then be calculated as:

$${σ}_{m} = \frac{{δ}_{m}}{{R}_{m} {A}_{m}} \qquad ( 3 )$$

where δₘ is the thickness of the membrane (75 μm for the CEM and 150 μm for the SSE) and Aₘ is the membrane area (6.45 cm²). Measurement of membrane conductivity was conducted in duplicates.

The potential difference measured across the capillaries (Δφₜₒₜ) includes the potential drop across the membrane as well as the potential drop across the solution layers (i.e., the solution between the capillary tips and the membrane surface). Hence, for the purpose of determining the membrane conductivity, the solution potential drop (Δφₛₒₗ) must be subtracted from the total measured potential difference. The solution potential drop was determined in each experiment by continuously measuring the conductivity in the feed solution in 20 s intervals and assuming that the measured conductivity is equal to that of the solution between the capillary tips and membrane. Thus, the potential difference across the membrane can be determined as:

$$Δ {ϕ}_{m} = Δ {ϕ}_{tot} - Δ {ϕ}_{sol} = Δ {ϕ}_{tot} - \frac{{d}_{tips} i}{{σ}_{sol}} \qquad ( 4 )$$

where i is the applied current density and dₜᵢₚₛ is the distance between the tips of the capillaries. The distance between the capillary tips was determined to be 2.1 mm by measuring the potential difference across the reference electrodes without the inclusion of the central membrane (i.e., Δφₛₒₗ=Δφₜₒₜ) at a fixed current density of 1 mA cm⁻².

The energy barrier for lithium transport across the central membrane was determined by assessing the temperature dependence of the membrane conductivity (i.e., permeability). Specifically, the membrane conductivity was measured at 25° C., 30° C., 35° C., and 40° C., where the temperature was controlled using a water bath. The bath temperature was maintained using a Cole Parmer water heater/circulator, while the temperatures in the bath and the lithium chloride feed solution were monitored using a thermometer and Oakton 4000 conductivity/temperature probe, respectively. To avoid heat loss during pumping of the solutions, the cell was submerged in the water bath up to the height of the titanium rods, which were the potentiostat lead connections. Each temperature was maintained for >30 mins, and measurements of the potential difference and solution conductivity were taken in ten-minute intervals. The average of the four collected data points at each temperature were utilized as the membrane conductivity. Each of the energy barrier experiments were performed in duplicates.

According to transition state theory, the enthalpic (ΔH) and entropic (ΔS) barriers for transport across a membrane are related to the membrane permeability (P) by:

$$P = \frac{{λ}_{i}^{2} {k}_{B} T}{h {δ}_{m}} {e}^{- Δ G / RT} = \frac{{λ}_{i}^{2} {k}_{B} T}{h {δ}_{m}} {e}^{Δ S / R} {e}^{- Δ H / RT} \qquad ( 5 )$$

where λ is the molecular jump length, k_{B} is the Boltzmann constant, T is the absolute temperature, h is Planck's constant, and R is the ideal gas constant, and the subscript i refers to either the SSE or CEM.

For electro-driven ion transport, the membrane permeability can be expressed in terms of the membrane conductivity according to:

$$P = \frac{R T {σ}_{m}}{{F}^{2} C {δ}_{m}} \qquad ( 6 )$$

where F is Faraday's constant and C is the ion concentration in the membrane. For the CEM, the ion concentration in the membrane is determined by measuring the ion-exchange capacity of the membrane in 500 mM LiCl and normalizing by the hydrated membrane volume. The concentration of lithium inside the SSE was approximated according to the stoichiometry reported by the manufacturer. By substituting Equation 6 into Equation 5, the energy barriers can be directly related to the temperature dependence of the membrane conductivity.

Electrodialysis Cell Design: A custom three-membrane/four-compartment electrodialysis cell was designed and fabricated, as shown in FIG. 2A Specifically, anion exchange membranes were utilized to separate the electrode rinse compartments from the inner serpentine flow channels. The inner flow channels serve as the feed and receiving channels, which make contact with the central membrane of interest, in this case the SSE or CEM).

Acrylic plates, which were 3 inch×3 inch×0.5 inch, were used as the endplates. Platinum coated (2.5 microns) titanium mesh electrodes (MSE Supplies) were used as both the anode and cathode and were inserted into appropriately sized grooves, which were 1 mm depth, in the acrylic endplates. An Ultra-Corrosion-Resistant Grade 2 titanium rod (McMaster Carr) was inserted through the acrylic endplates via a compression fitting and pushed against the electrodes, ensuring an electrically conductive connection between the potentiostat leads, which were clipped to the titanium rod, and the electrodes. The electrode rinse flow channels were cut as open 1 inch×1 inch squares into 0.5″ thick Garolite, while the inner flow channels, which run along the central membrane, were cut as serpentine paths into 0.05 inch thickness Garolite. The inner flow channels were kept as thin as possible to minimize solution resistance. For the measurement of membrane resistance and energy barriers, the serpentine inner flow paths were replaced with 1.25 inch depth square open channels, which were designed to allow for the insertion of Luggin capillaries which were 2 mm inner diameter.

Each of the membranes was sandwiched between a pair of EDPM gaskets to ensure scaling and to evenly distribute the force upon cell compression which was particularly important for the fragile SSE material. Holes were drilled into the gaskets and flow channels to direct the fluid flow and create four hydraulically separate flow paths, there were two electrode rinse solution flow paths, feed solution flow path, and a receiving solution flow path. The flow channels and holes were precisely cut into each material using a CNC milling machine. Upon assembly, the cell was compressed using stainless steel socket head screws.

Concentration Gradient Driven Transport Experiments: To assess the potential for purely diffusive transport of lithium through the SSE, the ED flow cell was utilized without the application of an external potential. A large transmembrane concentration gradient of lithium chloride was maintained across the SSE by recirculating 20 mL solutions of 0.5 mol L⁻¹ LiCl and ultrapure deionized water (>18.2 M (2 cm) through the feed and receiving solutions, respectively. A 150 mL solution of 0.5 mol L⁻¹ MgSO₄ was recirculated through the electrode rinse compartments to simultaneously assess concentration gradient driven transport through the AEM into the receiving compartment. The flowrate of the feed and receiving solutions was fixed at 1 mL min⁻¹, while the flowrate of the electrode rinse solution was 8 mL min⁻¹. Samples of 0.2 mL were periodically collected from the receiving solution and tested for cation composition using ion chromatography.

Water Transport and Stability Testing: The interaction of water with the SSE material was assessed through water uptake experiments. Four SSE fragments of varying mass were weighed prior to being immersed in 50 mL of deionized water. After the SSE fragments had been soaked for 48 hours, they were removed from the water, gently patted dry with a Kimwipe, and immediately weighed.

The stability of the SSE material in water was also evaluated by conducting lithium ion leaching experiments. Three fragments of the SSE were placed in 10.0 mL of ultrapure deionized water (>18.2 M (2 cm). Aliquots (0.2 mL) of the water were periodically taken over the course of one week and lithium concentration was measured using ion chromatography.

A custom-built diffusion cell was utilized to evaluate the relative water permeability of the SSE and CEM (FIG. 6). Specifically, a membrane coupon was clamped between two 60 mL glass compartments. One compartment was filled with an aqueous solution of 0.5 mol L-1 sucrose, while the other solution was filled with ultrapure deionized water (>18.2 M (2 cm). The volume of water transferred from the deionized water solution to the sucrose solution was determined by reading the level on a syringe attached to the sucrose solution compartment. The exposed membrane area available for water transport was 1.77 cm².

Determination of Energy Barriers: Transition state theory was applied to determine the energy barriers for lithium ion transport in the SSE and CEM. The permeability defined by Equation 6 can be substituted into Equation 5, resulting in the following relation, where Om is the membrane conductivity, h is Planck's constant, R is the ideal gas constant, A is the molecular jump length, KB is the Boltzmann constant, T is the absolute temperature, AS is the entropy of activation, A H is the enthalpic barrier for permeability, and the subscript i refers to either the SSE or CEM.

$$\frac{{σ}_{m} hR}{{λ}_{i}^{2} {k}_{B} {F}^{2} {C}_{i}} = {e}^{Δ S / R} {e}^{- Δ H / RT} \qquad ( 7 )$$

The linearized form of the equation is given by

$$ln ( \frac{{σ}_{m} hR}{{λ}_{i}^{2} {k}_{B} {F}^{2} {C}_{i}} ) = ln ( {σ}_{m} {α}_{i} ) = - \frac{1}{T} ( \frac{Δ H}{R} ) + \frac{Δ S}{R} \qquad ( 8 )$$

Where α is a parameter that lumps all constants. By plotting In (σₘα) versus 1/T, ΔH can be extracted from the slope. To determine the entropic energy barrier (i.e., in units of energy), it is necessary to assume that the entropy of activation is constant over the studied temperature range. Accordingly, the entropic energy barrier can be approximated as −T̅ΔS where T̅ is the average temperature for the studied range. The Arrhenius plots for the SSE and CEM are shown in FIG. 10 and the values for each of the parameters and energy barriers are provided in Table 3 and Table 4 below.

TABLE 3
Membrane conductivity for the CEM and SSE over
varying temperature for each replicate.

| | | Temperature | Conductivity |
|---|---|---|---|
| Membrane | Replicate | (° C.) | (mS cm⁻¹) |
| CEM | 1 | 25 | 1.33 |
| | | 30 | 1.75 |
| | | 35 | 2.19 |
| | | 40 | 2.96 |
| | 2 | 25 | 1.01 |
| | | 30 | 1.29 |
| | | 35 | 1.62 |
| | | 40 | 2.17 |
| SSE | 1 | 25 | 0.058 |
| | | 30 | 0.069 |
| | | 35 | 0.082 |
| | | 40 | 0.097 |
| | 2 | 25 | 0.061 |
| | | 30 | 0.071 |
| | | 35 | 0.085 |
| | | 40 | 0.099 |

TABLE 4
The determined energy barriers of the CEM and SSE for each replicate
along with the relevant membrane specific parameters.

| | λᵢ | Cᵢ | | ΔG | ΔH | −T̅ΔS |
|---|---|---|---|---|---|---|
| Membrane | (Å) | (mol L⁻¹) | Replicate | (kcal mol⁻¹) | (kcal mol⁻¹) | (kcal mol⁻¹) |
| CEM | 2.8 | 1.37 | 1 | 5.73 | 9.75 | −4.01 |
| | | | 2 | 5.92 | 9.33 | −3.41 |
| SSE | 4.0 | 13.1 | 1 | 9.52 | 6.45 | 3.07 |
| | | | 2 | 9.51 | 6.09 | 3.26 |

The average molecular jump length in the SSE can be reasonably approximated as 0.4 nm through evaluation of the crystal structure, along with the assumption that lithium ions primarily migrate via hops between lattice sites and metastable interstitial sites (Z. Y. Deng et al., Nature Communications 13, 4470 (2022)). In contrast, the elementary ion jumps in the CEM are more challenging to predict due to the relatively stochastic nature of ion transport through ion-exchange membranes. Previous work which aimed to model the activation behavior of ion-exchange membranes, nonetheless, has suggested that the ion jumps in ion exchange membranes may effectively be treated as those in bulk water, whereby each hop is effectively separated by the diameter of one water molecule (S. Mafé, et al., Phys Chem Chem Phys 5, 376-383 (2003)). Notably, the use of this assumption has also recently been experimentally validated, showing good agreement over a wide range of tested membranes and solutes. Thus, the CEM molecular jump length was assumed to be 0.28 nm.

The concentration of lithium ions inside the CEM (C) is approximated using standard ion-exchange capacity measurement techniques described in the literature. Specifically, a fresh CEM coupon (in Na-form) was brought into Li-form by soaking in 500 mM LiCl solution (50 mL) for >24 hours. The solution was replaced three times to ensure complete ion-exchange. After converting the CEM to Li-form, the CEM was converted back to Na-form following the same procedure, using 0.1 M NaCl solutions. The total quantity of lithium ions eluted was determined by summing the amount eluted into each of the NaCl elution solutions (measured with ICP-MS). The concentration in the membrane is calculated by normalizing the total moles of lithium ions eluted by the hydrated membrane geometric volume (determined by measuring the hydrated membrane thickness with a digital micrometer).

The concentration of lithium inside the SSE was approximated according to the stoichiometry reported by the manufacturer (Li₂O—Al₂O₃—SiO₂—P₂O₅—TiO₂—GeO₂). Specifically, the lithium ion concentration is determined according to the molecular weight of the SSE structure (MW_{SSE}), and the mass (m_{SSE}), area (Aₘ), and thickness (δₘ) of a fresh SSE membrane

$${C}_{SSE} = \frac{{m}_{SSE}}{{MW}_{SSE}} \times \frac{2 mol Li}{1 mol SSE} \times \frac{1}{{A}_{m} {δ}_{m}} \qquad ( 9 )$$

The experimentally derived lithium ion concentration in the SSE provided by (9) was also compared to a purely theoretical calculation based on the molecular structure and lattice volume. Particularly, it was assumed that the doped material utilized in this study has the same rhombohedral lattice unit cell dimensions as LiTi₂(PO₄)₃. Specifically, the LiTi₂(PO₄)₃ lattice has (a,b,c) dimensions of (8.623 Å, 8.623 Å, 21.081 Å) with angles between the bc, ac, and ab edges of 90.0°, 90.0°, and 120.0°, respectively. The unit cell volume (V_{uc}) for a rhombohedral lattice is given by

$${V}_{uc} = \frac{√ 3}{2} {a}^{2} c \qquad ( 10 )$$

where a and c are the respective unit cell dimensions. Hence, the theoretical lithium ion concentration within the SSE can be calculated by normalizing the number of lithium ions (Nu) in a Li₂O—Al₂O₃—SiO₂—P₂O₅—TiO₂—GeO₂ unit cell (i.e., 12 lithium ions per unit cell) by the unit cell volume.

$${C}_{SSE} = \frac{{N}_{Li}}{{V}_{uc}} \qquad ( 11 )$$

Using the experimental approach described by equation (9), a C_{SSE} of 13.15 mol L⁻¹ was obtained, while the theoretical approach of equation (11) gives a C_{SSE} of 14.7 mol L-1. Notably, the experimental and theoretical values show good agreement, with the discrepancy likely arising from the practical SSE membranes containing finite grain boundary volume, which is not reflected in the theoretical calculation. Hence, for the determination of energy barriers, the experimentally derived value was used.

Characterization of SSE: Characterization was performed on a pristine SSE and an SSE which had been utilized in a long-term (fifty hour) electrodialysis experiment with 10 mM LiCl and 10 mM NaCl in the feed solution. Before characterization, the SSE which had been used in the competitive ion transport experiment, was thoroughly washed with ultrapure deionized water and gently patted dry using a Kimwipe.

A Hitachi SU7000 field emission scanning electron microscope (FE-SEM) with an attached Princeton Gamma Tech EDS detector was utilized to map the elemental composition of the SSE cross-section. A 10 kV electron beam was used with variable pressure operation mode at 10 Pa to avoid applying a conductive coating to the SSE. A Rigaku SmartLab X-ray diffractometer (XRD) was utilized to assess the crystalline structure of the SSE samples. Diffraction patterns were collected from 10° to 90° with a step size of 0.01° using Cu K-α radiation.

Molecular Dynamics Simulations: In order to simulate the process of ions passing between two aqueous solutions through the SSE, a composite structure model was constructed using Materials Studio 2020. Three dimensional periodic models of LiCl solutions were constructed using the Amorphous Cell module, with dimensions of 44.8 Å×44.1 Å×38.2 Å and an initial density of 1 g/cm³. Three simulation boxes were assessed: pure LiCl, LiCl+NaCl, and LiCl+MgCl₂. The initial concentrations of sodium and magnesium ions in solution were equal to that of lithium in the relevant simulations. The thickness of the SSE is set to 8.6 Å, and a layer-by-layer structure is established through the build function.

The molecular structure of the simulation box was optimized using the Forcite Module with COMPASSII as the force field. During the geometric optimization, the convergence threshold for maximum energy change, maximum force, and maximum displacement were set to 0.001 kcal/mol, 0.5 kcal/mol/Å, and 0.015 Å, respectively. To release the internal stress in the system, a molecular dynamics (MD) simulation was performed under the NPT ensemble for 100 ps at 0.0001 GPa and 298 K until the density was stable over time. Further optimization of the system involved an MD simulation under the NVT ensemble for 100 ps. The simulation of ion passage involved the calculation of electrostatic interaction using Ewald and van der Waals force using atom base. Precise Nose-Hoover temperature control mode and Berendsen pressure control mode were used in the simulation, and the concentration of ions permeating the membranes was calculated at the end of the MD simulation. All the simulations were conducted at the temperature of 298 K with a step size of 0.5 fs.

PoreBlazer Simulations: To investigate the size exclusion based mechanism of the SSE, PoreBlazer v4.0 was utilized on the LiTi₂(PO₄)₃ lattice. The Universal Force Field (UFF) was applied throughout all the simulations. The simulation cell was specified to have (a,b,c) dimensions of (8.623 Å, 8.623 Å, 21.081 Å). The angles between the bc, ac, and ab edges of the unit cell were provided as 90.0°, 90.0°, and 120.0°, respectively. The size of the spherical probe was varied from 1.0 Å to 2.0 Å, and the fraction of the free volume occupiable by the probe (f_{probe}) was determined as:

$${f}_{probe} = \frac{{V}_{oc}}{{V}_{geom}} \qquad ( 12 )$$

where V_{oc} is the occupiable volume by the probe and V_{geom} is the total geometric volume of the interstitial space in the lattice (calculated as 286.2 Å³). The probe accessible sites were visualized by overlaying the probe occupiable volume output .xyz files with the LiTi₂(PO₄)₃ unit cell .xyz file in VESTA (L. Sarkisov, et al., Chem Mater 32, 9849-9867 (2020); K. Momma and F. Izumi, J Appl Crystallogr 44, 1272-1276 (2011)).

Approximation of Li/Mg Selectivity: Throughout all the competitive ion transport experiments, no sodium or magnesium flux was detected by ICP-MS. However, in order to quantify a lithium-magnesium selectivity to compare the results with reported values in the literature, the limit of detection of the ICP-MS was used to estimate a selectivity factor. As shown in FIG. 13, a calibration curve was generated using various concentrations of magnesium ranging from 0.1 ppb to 100 ppb. To closely match the composition of the samples from the competitive ion transport experiments and account for potential interference in measurement from co-occurring ions, all the standards were prepared in a background of 10 ppm potassium chloride and 0.5 ppm lithium chloride. The calibration curve showed excellent linear fit across all the prepared standards, including the lowest standard of 0.1 ppb. Hence, the limit of detection of magnesium was assumed to be ˜0.1 ppb, though it may be even lower on the Nexion 5000 ICP-MS utilized. The reported lithium-magnesium selectivity (S_{Li/Mg}) in FIG. 24A corresponds to the multi-salt experiments conducted with 10 mM Li and 10 mM Mg and was determined as:

$${S}_{L i / Mg} = \frac{Δ {C}_{L i} {C}_{f , Mg}}{Δ {C}_{M g} {C}_{f , Li}} = \frac{Δ {C}_{L i}}{{LOD}_{Mg} \times D F} \qquad ( 13 )$$

where ΔC is the change in the concentration of the species represented the subscript in the receiving solution over the duration of the experiment, C_{f} is the concentration of each species in the feed solution, LOD_{Mg} is the detection limit of magnesium, and DF is the dilution factor applied when preparing the samples from the multi-salt experiments for ICP-MS (i.e., 50).

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. An electrodialysis system, comprising:
a first chamber comprising a first chamber input and a first chamber output;
a first set of second and third chambers, wherein the second chamber comprises a second chamber input and a second chamber output, the third chamber comprises a third chamber input and a third chamber output, wherein the first chamber is electrically connected to an anode, and the third chamber is electrically connected to a cathode;
a first semipermeable membrane positioned between the first and second chambers and configured to allow ions to flow from the second chamber through the first semipermeable membrane and into the first chamber;
a solid-state electrolyte positioned between the second and third chambers and configured to allow ions to flow from the second chamber through the solid-state electrolyte and into the third chamber;
a feed channel having a feed channel inlet and a feed channel outlet, wherein the feed channel outlet is fluidly connected to the second chamber input and wherein the feed channel inlet is fluidly connected to the second chamber output;
a recovery channel having a recovery channel inlet and a recovery channel outlet, wherein the recovery channel outlet is fluidly connected to the first chamber input and the third chamber input and wherein the recovery channel inlet is fluidly connected to the first chamber output and the third chamber output; and
a sample port fluidly connected to the recovery channel.

2. The system of claim 1, further comprising a concentrator fluidly connected to the recovery channel.

3. The system of claim 2, wherein the concentrator is fluidly connected to the feed channel.

4. The system of claim 2, further comprising a carbon dioxide channel fluidly connected to the recovery channel.

5. The system of claim 4, wherein the concentrator is fluidly connected to the recovery channel downstream of the carbon dioxide channel.

6. The system of claim 1, wherein the system further comprises a second set of second and third chambers positioned between the first semipermeable membrane and first set of second and third chambers.

7. The system of claim 1, wherein the semipermeable membrane is selected from the group consisting of a solid-state electrolyte, a bipolar membrane, a cation exchange membrane, and an anion exchange membrane.

8. The system of claim 1, wherein the solid-state electrolyte is a sodium super ionic conducting solid-state electrolyte or a lithium super ionic conducting solid state electrolyte.

9. The system of claim 1, wherein the solid-state electrolyte has a lithium/magnesium selectivity factor of at least 100.

10. The system of claim 1, wherein the solid-state electrolyte has a lithium/sodium selectivity factor of at least 100.

11. A method of purifying an ion in a solution, the method comprising the steps of:
providing a feed solution comprising an ion;
contacting the feed solution with a solid-state electrolyte;
applying a current to the solid-state electrolyte such that the ion passes through the solid-state electrolyte to create a recovery solution comprising the ion; and
collecting the ion.

12. The method of claim 11, wherein the step of applying a current to the solid-state electrolyte such that the ion passes through the solid-state electrolyte to create a recovery solution further comprises the step of recirculating the feed solution such that it contacts the solid-state electrolyte again.

13. The method of claim 11, wherein the step of applying a current to the solid-state electrolyte such that the ion passes through the solid-state electrolyte to create a recovery solution further comprises the step of passing the recovery solution to a concentrator.

14. The method of claim 13, wherein the step of passing the recovery solution to a concentrator further comprises the step of adding a salt to the concentrator to induce precipitation of the ion.

15. The method of claim 11, wherein the step of applying a current to the solid-state electrolyte such that the ion passes through the solid-state electrolyte to create a recovery solution further comprises the step of contacting the recovery solution with a semipermeable membrane in the presence of the current.

16. The method of claim 11, wherein the step of applying a current to the solid-state electrolyte such that the ion passes through the solid-state electrolyte to create a recovery solution further comprises the step of contacting the recovery solution with carbon dioxide.

17. The method of claim 11, wherein the feed solution comprising an ion is aqueous.

18. The method of claim 11, wherein the pH of the feed solution comprising an ion is between 2 and 11.

19. The method of claim 11, wherein the ion is lithium.

20. The method of claim 11, wherein the solid-state electrolyte is a sodium super ionic conducting solid-state electrolyte or a lithium super ionic conducting solid state electrolyte.
